(19) United States
(12) Patent Application Publication
(10) Pub. No.: US 2012/0178339 A1
(43) Pub. Date: Jul. 12, 2012

(54) Moving Attachments for a Vibration Powered Toy

(76) Inventors: Robert H. Mimlitch, III, Rowlett, TX (US); David Anthony Norman, Greenville, TX (US); Gregory E. Needel, Rockwall, TX (US); Jeffrey R. Waegelin, Rockwall, TX (US); Douglas Michael Galletti, Allen, TX (US); Joel Reagan Carter, Argyle, TX (US)

(21) Appl. No.: 13/004,783

(22) Filed: Jan. 11, 2011

(51) Int. Cl. A63H 29/22; B23P 17/04

(52) U.S. Cl. 446/484; 29/428

(57) ABSTRACT

An apparatus includes an appendage rotatably coupled to a body of a device adapted to move based on internally induced vibration of the device. The appendage can be attached directly to the body of the device or to a frame that is adapted to releasably attach to the device. The appendage is adapted to rotate about an axis of rotation as vibration induces motion of the device. The device can include a body, an eccentric load, a rotational motor coupled to the body and adapted to rotate the eccentric load, and a plurality of legs each having a leg base and a leg tip at a distal end relative to the leg base. At least one driving leg configured to cause the apparatus to move in a direction generally defined by an offset between the leg base and the leg tip as the rotational motor rotates the eccentric load.

### BACKGROUND

This specification relates to devices that move based on oscillatory motion and/or vibration.

One example of vibration driven movement is a vibrating electric football game. A vibrating horizontal metal surface induced inanimate plastic figures to move randomly or slightly directionally. More recent examples of vibration driven motion use internal power sources and a vibrating mechanism located on a vehicle.

One method of creating movement-inducing vibrations is to use rotational motors that spin a shaft attached to a counterweight. The rotation of the counterweight induces an oscillatory motion. Power sources include wind up springs that are manually powered or DC electric motors. The most recent trend is to use pager motors designed to vibrate a pager or cell phone in silent mode. Vibrobots and Bristlebots are two modern examples of vehicles that use vibration to induce movement. For example, small, robotic devices, such as Vibrobots and Bristlebots, can use motors with counterweights to create vibrations. The robots' legs are generally metal wires or stiff plastic bristles. The vibration causes the entire robot to vibrate up and down as well as rotate. These robotic devices tend to drift and rotate because no significant directional control is achieved.

Vibrobots tend to use long metal wire legs. The shape and size of these vehicles vary widely and typically range from short 2″ devices to tall 10″ devices. Rubber feet are often added to the legs to avoid damaging tabletops and to alter the friction coefficient. Vibrobots typically have 3 or 4 legs, although designs with 10-20 exist. The vibration of the body and legs creates a motion pattern that is mostly random in direction and in rotation. Collision with walls does not result in a new direction and the result is that the wall only limits motion in that direction. The appearance of lifelike motion is very low due to the highly random motion.

Bristlebots are sometimes described in the literature as tiny directional Vibrobots. Bristlebots use hundreds of short nylon bristles for legs. The most common source of the bristles, and the vehicle body, is to use the entire head of a toothbrush. A pager motor and battery complete the typical design. Motion can be random and directionless depending on the motor and body orientation and bristle direction. Designs that use bristles angled to the rear with an attached rotating motor can achieve a general forward direction with varying amounts of turning and sideways drifting. Collisions with objects such as walls cause the vehicle to stop then turn left or right and continue on in a general forward direction. The appearance of lifelike motion is minimal due to a gliding movement and a zombie-like reaction to hitting a wall.

### SUMMARY

In general, one innovative aspect of the subject matter described in this specification can be embodied in apparatus that include a frame adapted to releasably attach to a body of a device that is configured to move based on internally induced vibration of the device and an appendage rotatably coupled to the frame. The appendage is adapted to rotate about an axis of rotation when the frame is attached to the body of the device as vibration induces motion of the device.

These and other embodiments can each optionally include one or more of the following features. The frame includes a plurality of tabs adapted for releasably attaching the frame to the body of the device. The frame further includes a surface opposing the plurality of tabs, and the surface and the plurality of tabs are adapted to engage a portion of the body of the device. The frame includes an interior concave portion shaped to substantially conform to an exterior portion of the body of the device. The axis of rotation is defined by an axle that rotatably couples the appendage to the frame. The axis of rotation is situated at least substantially parallel to a direction of movement of the device as vibration induces motion of the device when the frame is attached to the body of the device. The axis of rotation is situated at least substantially perpendicular to a direction of movement of the device as vibration induces motion of the device when the frame is attached to the body of the device. The appendage is adapted to rotate in a particular direction based on the vibration of the device when the frame is attached to the body of the device. The appendage is adapted to rotate back and forth as the device vibrates when the frame is attached to the body of the device. A plurality of appendages rotatably coupled to the frame, and each appendage is adapted to rotate about a respective axis of rotation when the frame is attached to the body of the device as vibration induces motion of the device. The frame is substantially rigid. The internally induced vibration of the device is induced using a rotational motor coupled to the body of the device and an eccentric load, and the rotational motor is adapted to rotate the eccentric load. The axis of rotation is situated at least substantially parallel to a rotational axis of the rotational motor as the rotational motor rotates the eccentric load when the frame is attached to the body of the device. The axis of rotation is situated at least substantially perpendicular to a rotational axis of the rotational motor as the rotational motor rotates the eccentric load when the frame is attached to the body of the device. The appendage is configured to resemble one of a saw blade, a swinging blade, a rocking wing, a steammoller drum, or a drill bit. The motion of the device includes vibration-induced motion across a support surface for the device.

In general, another innovative aspect of the subject matter described in this specification can be embodied in methods that include the acts of attaching a frame to a body of a device adapted to move based on vibration of the device, inducing vibration of the device using a vibrating mechanism attached to the device, and inducing movement of an appendage rotatably coupled to the frame. The movement of the appendage includes rotation about an axis of rotation and is based on vibration of the device induced by the vibrating mechanism when the frame is attached to the body of the device.

These and other embodiments can each optionally include one or more of the following features. At least a first frame and a second frame are attached to different sections of the body of the device, and each frame is rotatably coupled to at least one appendage adapted to rotate about a respective axis of rotation. The frame is attached to the body of the device by engaging the body of the device with a plurality of tabs attached to the frame and a surface of the frame opposing the plurality of tabs. The plurality of tabs can be disengaged to remove the frame from the body of the device. The frame is attached to the body of the device by engaging an interior concave portion shaped to substantially conform to an exterior portion of the body of the device. The axis of rotation is defined by an axle that rotatably couples the appendage to the frame. Substantially forward motion of the device is induced based on the induced vibration, and the axis of rotation is situated at least substantially parallel to a direction of forward motion of the device. Substantially forward motion of the device is induced based on the induced vibration, and the axis of rotation is situated at least substantially perpendicular to a direction of forward motion of the device. The appendage repeatedly and substantially continuously rotates in a particular direction based on the vibration of the device when the frame is attached to the body of the device. The appendage rotates back and forth as the device vibrates when the frame is attached to the body of the device. The vibration of the device is induced using a rotational motor coupled to the body of the device and an eccentric load, and the rotational motor is adapted to rotate the eccentric load. The vibration of the device induces motion across a support surface for the device.

In general, another innovative aspect of the subject matter described in this specification can be embodied in apparatus that include a body, an appendage rotatably coupled to the body, a rotational motor coupled to the body, an eccentric load, and a plurality of legs. The rotational motor is adapted to rotate the eccentric load, and the appendage is adapted to rotate about an axis of rotation due to forces induced when the rotational motor rotates the eccentric load. The plurality of legs each have a leg base and a leg tip at a distal end relative to the leg base, and the plurality of legs include at least one driving leg configured to cause the apparatus to move in a direction generally defined by an offset between the leg base and the leg tip as the rotational motor rotates the eccentric load.

These and other embodiments can each optionally include one or more of the following features. At least a portion of the plurality of legs are constructed from a flexible material, are injection molded, and are integrally coupled to the body at the leg base. The legs are arranged in two rows, with the leg base of the legs in each row coupled to the body substantially along a lateral edge of the body. The body includes a housing, the rotational motor is situated within the housing, and at least a portion of the housing is situated between the two rows of legs. The rotational motor has an axis of rotation that passes within about 20% of the center of gravity of the apparatus as a percentage of the height of the apparatus. The plurality of legs are arranged in two rows and the rows are substantially parallel to the axis of rotation of the rotational motor, and at least some of the leg tips tend to substantially prevent rolling of the apparatus based on a spacing of the two rows of legs when the legs are oriented such that a leg tip of at least one leg on each lateral side of the body contacts a substantially flat surface. Forces from rotation of the eccentric load interact with a resilient characteristic of the at least one driving leg to cause the at least one driving leg to leave a support surface as the apparatus translates in the forward direction. A coefficient of friction of a portion of at least a subset of the legs that contact a support surface is sufficient to substantially eliminate drifting in a lateral direction. The legs are sufficiently stiff that four or fewer legs are capable of supporting the apparatus without substantial deformation when the apparatus is in an upright position. The eccentric load is configured to be located toward a front end of the apparatus relative to the driving legs, wherein the front end of the apparatus is defined by an end in a direction that the apparatus primarily tends to move as the rotational motor rotates the eccentric load. The plurality of legs are integrally molded with at least a portion of the body. The plurality of legs are co-molded with at least a portion of the body constructed from a different material. At least a subset of the plurality of legs, including the at least one driving leg, are curved, and a ratio of a radius of curvature of the curved legs to leg length of the curved legs is in a range of 2.5 to 20. The flexible material includes an elastomer. Each of the plurality of legs has a diameter of at least five percent of a length of the leg between the leg base and the leg tip.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example vibration powered device.

FIGS. 2A through 2F illustrate a vehicle that includes a device of FIG. 1 fitted with a spinning drill head attachment.

FIGS. 3A through 3F illustrate the spinning drill head attachment of FIGS. 2A-2F separate from the device of FIG. 1.

FIGS. 4A through 4F illustrate a vehicle that includes a device of FIG. 1 fitted with a top spinning saw blade head attachment.

FIGS. 5A through 5F illustrate the top spinning saw blade head attachment of FIGS. 4A-4F separate from the device of FIG. 1.

FIGS. 6A through 6F illustrate a vehicle that includes a device of FIG. 1 fitted with a front sideways spinning saw blade head attachment.

FIGS. 7A through 7F illustrate the front sideways spinning saw blade head attachment of FIGS. 6A-6F separate from the device of FIG. 1.

FIGS. 8A through 8F illustrate a vehicle that includes a device of FIG. 1 fitted with a front waving side-to-side blade attachment.

FIGS. 9A through 9F illustrate the front waving side-to-side blade attachment of FIGS. 8A-8F separate from the device of FIG. 1.

FIGS. 10A through 10F illustrate a vehicle that includes a device of FIG. 1 fitted with a rocking wing body attachment.

FIGS. 11A through 11F illustrate the rocking wing body attachment of FIGS. 10A-10F separate from the device of FIG. 1.

FIGS. 12A through 12F illustrate a vehicle that includes a device of FIG. 1 fitted with a rocking wing tail attachment.

FIGS. 13A through 13F illustrate the rocking wing tail attachment of FIGS. 12A-12F separate from the device of FIG. 1.

FIGS. 14A through 14F illustrate a vehicle that includes a device of FIG. 1 fitted with a dual side saw blades attachment.

FIGS. 15A through 15F illustrate the dual side saw blades attachment of FIGS. 14A-14F separate from the device of FIG. 1.

FIGS. 16A through 16F illustrate a vehicle that includes a device of FIG. 1 fitted with a spinning top blade body attachment.

FIGS. 17A through 17F illustrate the spinning top blade body attachment of FIGS. 16A-16F separate from the device of FIG. 1.

FIGS. 18A through 18F illustrate a vehicle that includes a device of FIG. 1 fitted with a front rotating drum attachment.

FIGS. 19A through 19F illustrate the front rotating drum attachment of FIGS. 18A-18F separate from the device of FIG. 1.

FIGS. 20A through 20F illustrate a vehicle that includes a device of FIG. 1 fitted with a side-to-side waving tail attachment.

FIGS. 21A through 21F illustrate the side-to-side waving tail attachment of FIG. 20 separate from the device of FIG. 1.

FIGS. 22A through 22F illustrate a vehicle that includes a device of FIG. 1 fitted with a rear sideways spinning blade attachment.

FIGS. 23A through 23F illustrate the rear sideways spinning blade attachment of FIG. 22 separate from the device of FIG. 1.

FIGS. 24A through 24D illustrate a vehicle that includes a device of FIG. 1 fitted with both moving and non-moving parts.

FIGS. 25A through 25D illustrate a vehicle that includes a device of FIG. 1 fitted with multiple moving parts.

FIGS. 26A through 26D illustrate a vehicle that includes a device of FIG. 1 fitted with both moving and non-moving parts.

FIGS. 27A through 27D illustrate a vehicle that includes a device of FIG. 1 fitted with both moving and non-moving parts.

FIG. 28 is a flow diagram of a process for using a device and one or more attachments.

Like reference numbers and designations in the various drawings indicate like elements.

### DETAILED DESCRIPTION

Small robotic devices, or vibration-powered vehicles, can be designed to move across a surface, e.g., a floor, table, or other relatively flat surface. The robotic device is adapted to move autonomously and, in some implementations, turn in seemingly random directions. In general, the robotic devices include a housing, multiple legs, and a vibrating mechanism (e.g., a motor or spring-loaded mechanical winding mechanism rotating an eccentric load, a motor or other mechanism adapted to induce oscillation of a counterweight, or other arrangement of components adapted to rapidly alter the center of mass of the device). As a result, the miniature robotic devices, when in motion, can resemble organic life, such as bugs or insects.

Movement of the robotic device can be induced by the motion of a rotational motor inside of, or attached to, the device, in combination with a rotating weight with a center of mass that is offset relative to the rotational axis of the motor. The rotational movement of the weight causes the motor and the robotic device to which it is attached to vibrate. In some implementations, the rotation is approximately in the range of 6000-9000 revolutions per minute (rpm's), although higher or lower rpm values can be used. As an example, the device can use the type of vibration mechanism that exists in many pagers and cell phones that, when in vibrate mode, cause the pager or cell phone to vibrate. The vibration induced by the vibration mechanism can cause the device to move across the surface (e.g., the floor) using legs that are configured to alternately flex (in a particular direction) and return to the original position as the vibration causes the device to move up and down. The robotic device can include features and be constructed as described in U.S. patent application Ser. No. 12/860,696, entitled “Vibration Powered Vehicle,” filed Aug. 20, 2010, which is incorporated herein by reference in its entirety.

Various features can be incorporated into the robotic devices. For example, various implementations of the devices can include features (e.g., shape of the legs, number of legs, frictional characteristics of the leg tips, relative stiffness or flexibility of the legs, resiliency of the legs, relative location of the rotating counterweight with respect to the legs, etc.) for facilitating efficient transfer of vibrations to forward motion. The speed and direction of the robotic device's movement can depend on many factors, including the rotational speed of the motor, the size of the offset weight attached to the motor, the power supply, the characteristics (e.g., size, orientation, shape, material, resiliency, frictional characteristics, etc.) of the “legs” attached to the housing of the device, the properties of the surface on which the device operates, the overall weight of the device, and so on.

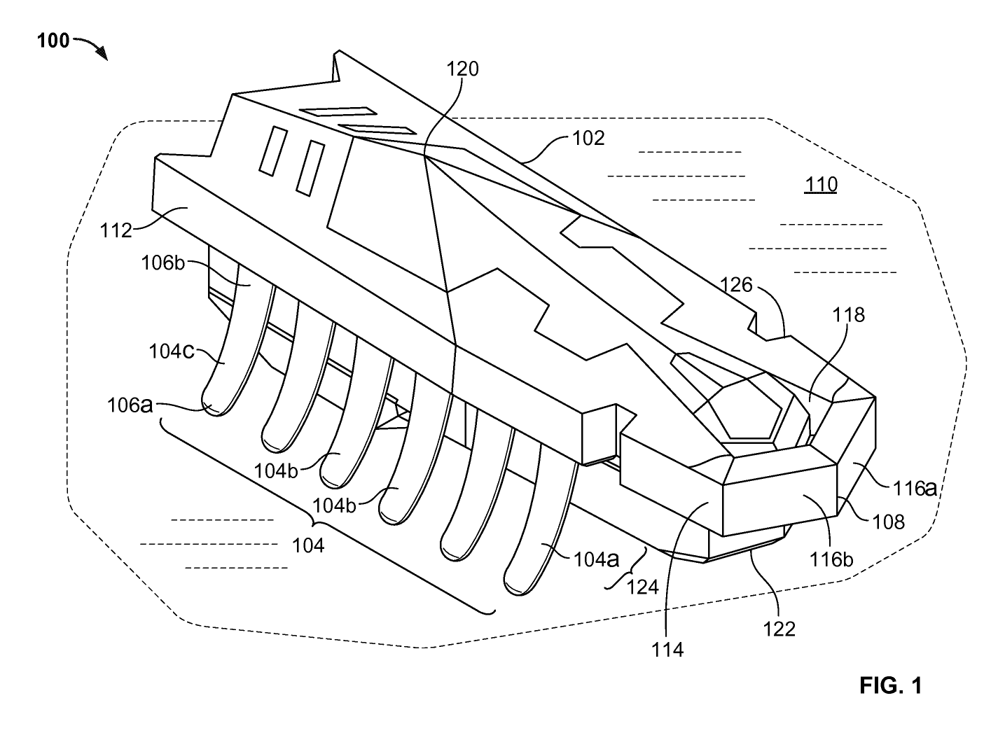

FIG. 1 is a diagram that illustrates an example device 100 that is shaped like an insect. The device 100 includes a housing 102 (e.g., resembling the body of the insect) and legs 104. Inside (or attached to) the housing 102 are the components that control and provide movement for the device 100, including a rotational motor, power supply (e.g., a battery), and an on/off switch. Each of the legs 104 includes a leg tip 106a and a leg base 106b. The properties of the legs 104, including the position of the leg base 106b relative to the leg tip 106a, can contribute to the direction and speed in which the device 100 tends to move. The device 100 is depicted in an upright position (i.e., standing on legs 104) on a supporting surface 110 (e.g., a substantially planar floor, table top, etc. that counteracts gravitational forces).

Legs 104 can include front legs 104a, middle legs 104b, and rear legs 104c. For example, the device 100 can include a pair of front legs 104a that may be designed to perform differently from middle legs 104b and rear legs 104c. For example, the front legs 104a may be configured to provide a driving force for the device 100 by contacting an underlying surface 110 and causing the device to hop forward as the device vibrates. Middle legs 104b can help provide support to counteract material fatigue (e.g., after the device 100 rests on the legs 104 for long periods of time) that may eventually cause the front legs 104a to deform and/or lose resiliency. In some implementations, device 100 can exclude middle legs 104b and include only front legs 104a and rear legs 104c. In some implementations, front legs 104a and one or more rear legs 104c can be designed to be in contact with a surface, while middle legs 104b can be slightly off the surface so that the middle legs 104b do not introduce significant additional drag forces and/or hopping forces that may make it more difficult to achieve desired movements (e.g., tendency to move in a relatively straight line and/or a desired amount of randomness of motion).

As described here at a high level, many factors or features can contribute to the movement and control of the device 100. For example, the device's center of gravity (CG), and whether it is more forward or towards the rear of the device, can influence the tendency of the device 100 to turn. Moreover, a lower CG can help to prevent the device 100 from tipping over. The location and distribution of the legs 104 relative to the CG can also prevent tipping. For example, if pairs or rows of legs 104 on each side of the device 100 are too close together and the device 100 has a relatively high CG (e.g., relative to the lateral distance between the rows or pairs of legs), then the device 100 may have a tendency to tip over on its side. Thus, in some implementations, the device includes rows or pairs of legs 104 that provide a wider lateral stance (e.g., pairs of front legs 104a, middle legs 104b, and rear legs 104c are spaced apart by a distance that defines an approximate width of the lateral stance) than a distance between the CG and a flat supporting surface on which the device 100 rests in an upright position. In some implementations, a high point 120 can be used to help facilitate self-righting of the device 100 in the event that the device 100 tips over onto its back.

Movement of the device can also be influenced by the leg geometry of the legs 104. For example, a longitudinal offset between the leg tip (i.e., the end of the leg that touches the surface 110) and the leg base (i.e., the end of the leg that attaches to the device housing) of any driving legs induces movement in a forward direction as the device vibrates. Including some curvature, at least in the driving legs, further facilitates forward motion as the legs tend to bend, moving the device forward, when vibrations force the device downward and then spring back to a straighter configuration as the vibrations force the device upward (e.g., resulting in hopping completely or partially off the surface, such that the leg tips move forward above or slide forward across the surface 110).

The ability of the legs to induce forward motion results in part from the ability of the device to vibrate vertically on the resilient legs. As shown in FIG. 1, the device 100 includes an underside 122. The power supply and motor for the device 100 can be contained in a chamber that is formed between the underside 122 and the upper body of the device, for example. The length of the legs 104 creates a space 124 (at least in the vicinity of the driving legs) between the underside 122 and the surface 110 on which the device 100 operates. The size of the space 124 depends on how far the legs 104 extend below the device relative to the underside 122. The space 124 provides room for the device 100 (at least in the vicinity of the driving legs) to move downward as the periodic downward force resulting from the rotation of the eccentric load causes the legs to bend. This downward movement can facilitate forward motion induced by the bending of the legs 104.

The device also includes a body shoulder 112 and a head side surface 114, which can be constructed from rubber, elastomer, or other resilient material, or from a hard plastic, metal, or other material. A notch 126 can separate the body shoulder 112 the head side surface 114. A nose 108 can contribute to the ability of the device 100 to deflect off of obstacles. Nose left side 116a and nose right side 116b can form the nose 108. The nose sides 116a and 116b can form a shallow point or another shape that helps to cause the device 100 to deflect off obstacles (e.g., walls) encountered as the device 100 moves in a generally forward direction. The device 100 can includes a space within the head 118 that increases bounce by making the head more elastically deformable (i.e., reducing the stiffness). For example, when the device 100 crashes nose-first into an obstacle, the space within the head 118 allows the head of the device 100 to compress, which provides greater control over the bounce of the device 100 away from the obstacle than if the head 118 is constructed as a more solid block of material. The space within the head 118 can also better absorb impact if the device falls from some height (e.g., a table). The body shoulder 112 and head side surface 114, especially when constructed from rubber or other resilient material, can also contribute to the device's tendency to deflect or bounce off of obstacles encountered at a relatively high angle of incidence.

Attachments can be designed to fit on the device 100 to add functionality and/or change the appearance of the device 100. In some embodiments, the attachments can resemble weapons and/or armor, although other types of attachments are also possible (e.g., attachments that tend to alter the movement or other behavior of the device 100). The attachments can include static or moving parts. In some embodiments, an attachment can include a frame that can be conveniently attached to and removed from (i.e., releasably attached to) the housing 102 (i.e., the body) of the device 100. The frame can be designed to attach to different portions of the body (e.g., head, center, or tail end of the device 100, or a combination thereof). The frame can be shaped to mate with a particular portion of the housing 102 to facilitate positioning of the attachment in a particular location and to secure the attachment to the housing 102 in a relatively reliable configuration. The frame can be constructed from a resilient material (e.g., rubber or other elastomer) or a stiff material (e.g., hard plastic or metal). Moreover, in some embodiments, the frame may be integrally attached to (e.g., co-molded with at least a portion of the housing 102) or otherwise connected to the device 100 in a manner that is not removable.

The attachment can also include one or more appendages that are rotatably coupled to the frame (e.g., using an axle). The appendage can have any suitable shape and can rotate about a corresponding axis of rotation as the device 100 vibrates. For example, as vibration induces motion of the device 100, the vibration (or other forces induced by rotation of the eccentric load) can further induce rotation of the appendage about its axis of rotation. Thus, the appendage can rotate without any direct torque transfer from the motor of the device 100 (i.e., there are no gears or other mechanisms for the rotational motion of the motor in the device to drive the rotation of the appendage). Rotation of the appendage may be induced, at least in part, by lateral oscillation of the device 100 or by vibration that results from rotation of an eccentric load by a rotational motor. The speed and direction of rotation of the appendage may be related to the speed and amplitude of vibration of the device; to the direction of rotation of and degree of eccentricity induced by the eccentric load; the amount of rotational momentum; to the orientation of the axis of rotation of the appendage. The axis of rotation of the appendage can be parallel to the direction of motion of the device 100, can be perpendicular to the direction of motion, or can have some other orientation. Moreover, the axis of rotation can be parallel to the supporting surface 110 of the device 100 (i.e., when the device 100 is upright), perpendicular to the supporting surface, or some other orientation. Depending on the configuration of the appendage, the appendage can, in various embodiments, increase erratic or random motion tendencies of the device 100, increase or decrease stability of the device 100, or alter interactive tendencies with obstacles or other devices 100.

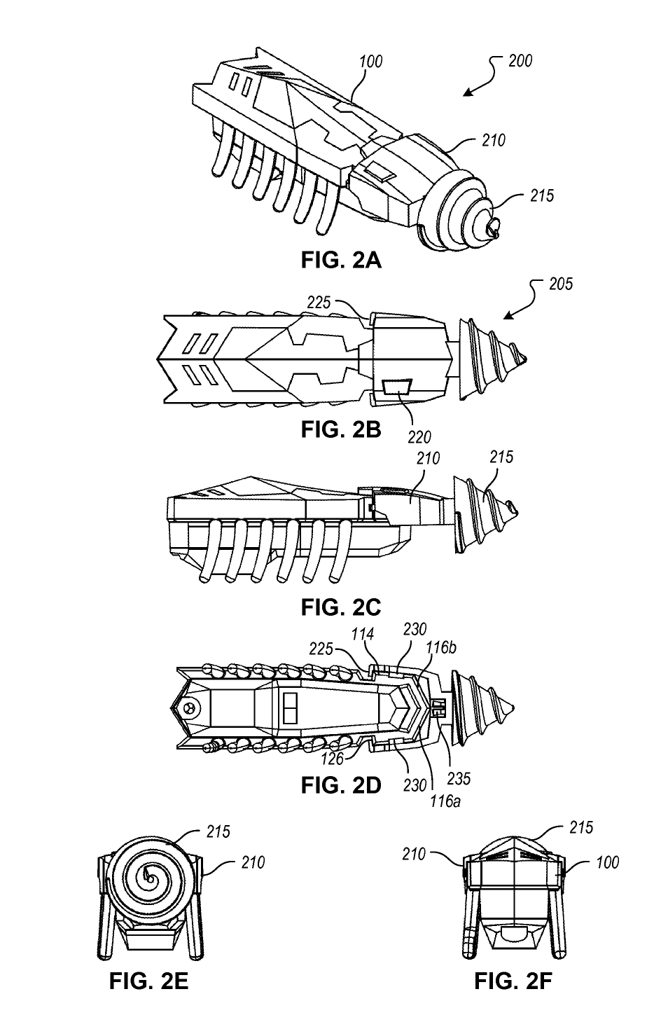

A variety of example embodiments of attachments are described in the following paragraphs. Although the figures illustrate attachments designed to fit the device 100 of FIG. 1, attachments can also be shaped to fit devices having alternative shapes. In addition to the utility of the various embodiments, each set of figures (e.g., FIGS. 2A-2F, FIGS. 3A-3F, FIGS. 4A-4F) also illustrate inventive ornamental designs for the device 100 in combination with various attachments and for the attachments themselves. Inventive design features may include portions of the illustrated structures.

FIGS. 2A through 2F illustrate a vehicle 200 that includes a device 100 of FIG. 1 fitted with a spinning drill head attachment 205. FIG. 2A is a perspective view of the vehicle 200, FIG. 2B is a top view of the vehicle 200, FIG. 2C is a side view of the vehicle 200, FIG. 2D is a bottom view of the vehicle 200, FIG. 2E is a front view of the vehicle 200, and FIG. 2F is a back view of the vehicle 200. The spinning drill head attachment 205 includes a frame 210 and a drill bit appendage 215. The frame 210 can include surface or three-dimensional ornamentation 220. Such ornamentation 220, in addition to providing aesthetic features, can provide an altered weight distribution of the vehicle 200 relative to the device 100 or relative to a vehicle similar to vehicle 200 that does not include the ornamentation 220. The altered weight distribution can counteract or otherwise alter motion tendencies induced by rotation of the appendage or can simply impact motion tendencies of the combined vehicle 200 as the device 100 vibrates.

The frame 210 can include features adapted to secure the attachment 205 to the device 100. For example, the frame 210 can include vertical tabs 225 adapted to engage a surface of the notch 126 that separates the head from the body of the device 100 (see FIG. 1) to prevent unwanted movement of the attachment 205 in a forward direction (i.e., in a direction toward the nose 108 of the device 100). The frame 210 can also include horizontal tabs 230 adapted to engage the device 100 just under the head side surface 114 to prevent unwanted movement of the attachment 205 in an upward direction (i.e., in a direction away from a support surface 110 when the device 100 is upright). Essentially, the vertical tabs 225 and horizontal tabs 230 can allow the attachment 205 to snap into place on the device 100 and to be removed from the device 100 (e.g., using an amount of force greater than the device 100 experiences as a result of vibration during operation). The tabs 225 and 230, the frame 210, and/or the body 102 of the device 100 can be sufficiently flexible to deflect and/or deform, thereby allowing the attachment 205 to be fitted onto the device 100 and removed from the device 100 by a user. The frame 210 may be configured to have at least a somewhat different internal shape than the shape of the device body 102 (e.g., the front portion of the frame 210 need not conform to the shape of nose sides 116a, 116b, although, in some embodiments, frame 210 can be configured to conform to the shape of the nose sides 116a, 116b). As noted above, in some embodiments the frame can be connected (integrally or otherwise) to the device body 102 instead of being a separate and/or removable component.

The drill bit appendage 215 is rotatably coupled to the frame 210 of the spinning drill head attachment 205 by a screw 235 that serves as an axle and defines an axis of rotation for the spinning drill bit appendage 215. Although the attachment 205 is illustrated as using a screw 235, other types of axles (e.g., a rod that projects from the frame that mates with a hollow cylinder of the appendage 215) can also be used. Moreover, the axle can be fixedly attached to either the frame 210 or the appendage 215, or neither.

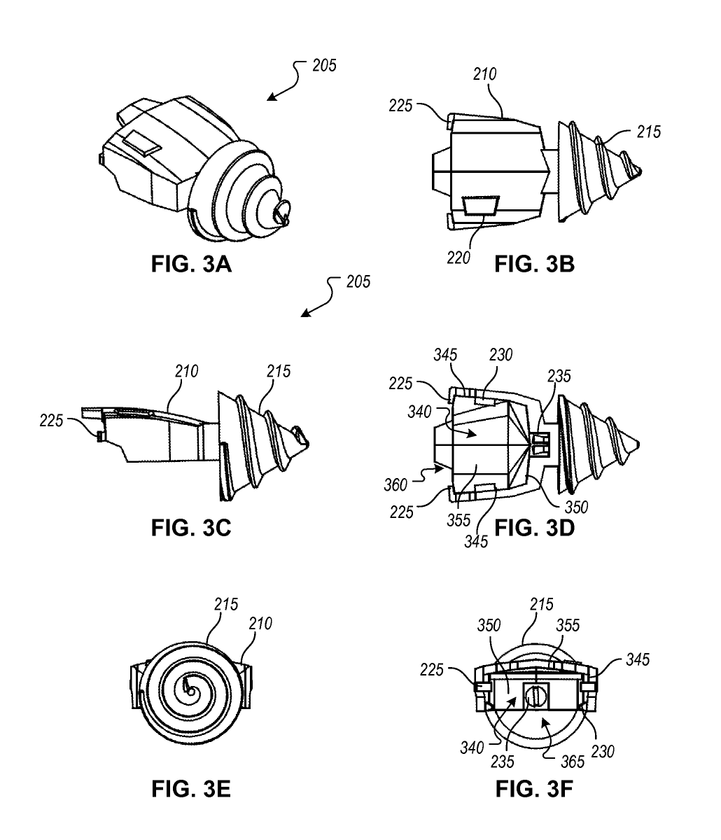

FIGS. 3A through 3F illustrate the spinning drill head attachment 205 of FIGS. 2A-2F separate from the device 100. FIG. 3A is a perspective view of the spinning drill head attachment 205, FIG. 3B is a top view of the spinning drill head attachment 205, FIG. 3C is a side view of the spinning drill head attachment 205, FIG. 3D is a bottom view of the spinning drill head attachment 205, FIG. 3E is a front view of the spinning drill head attachment 205, and FIG. 3F is a back view of the spinning drill head attachment 205. FIGS. 3A-3F illustrate many of the same features as shown in FIGS. 2A-2F. In addition, FIGS. 3D and 3F illustrate additional details of a concave portion 340 of the spinning drill head attachment 205 that fits onto the device 100. In this case, for example, the concave portion 340 is designed to substantially mate with a head portion of the device 100 of FIG. 1.

As shown in FIGS. 3D and 3F, the concave portion 340 is defined by sidewalls 345, a front wall 350, and a top wall 355. The sidewalls 345 of the concave portion 340 terminate at the rear of the frame 210 to define a rear opening 360 and at the bottom of the frame 210 to define a bottom opening 365. Using these openings, the device 100 can be inserted into the attachment 205 from the rear opening 360 or the bottom opening 365 (or a combination). The sidewalls 345 and top wall 355 are illustrated as having a shape that generally conforms to the shape of the corresponding portion of the device 100. The front wall 350 is illustrated as have a shape that does not conform to the nose portion 108, 116a, 116b of the device 100, although the front wall 350 may be designed to contact at least a portion of the nose 108 to provide a surface that opposes the vertical tabs 225. Thus, although the internal dimensions of the concave portion 340 may not conform precisely to the shape of a corresponding portion of the device 100, the internal dimensions may include surfaces that contact the corresponding portion of the device 100 sufficiently to secure the attachment 205 in place.

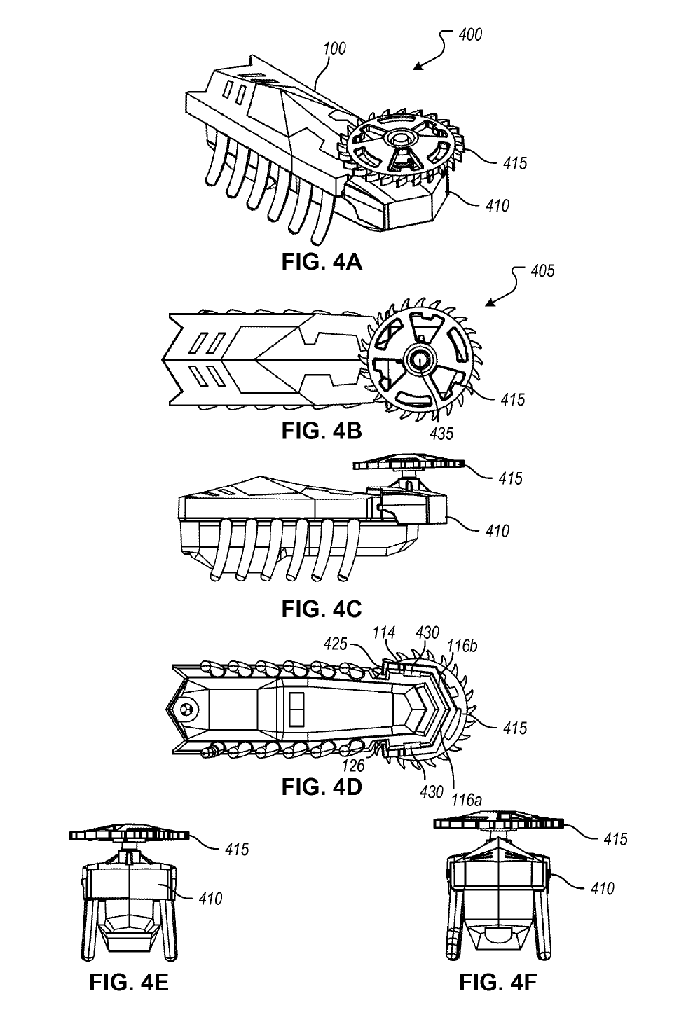

FIGS. 4A through 4F illustrate a vehicle 400 that includes a device 100 of FIG. 1 fitted with a top spinning saw blade head attachment 405. FIG. 4A is a perspective view of the vehicle 400, FIG. 4B is a top view of the vehicle 400, FIG. 4C is a side view of the vehicle 400, FIG. 4D is a bottom view of the vehicle 400, FIG. 4E is a front view of the vehicle 400, and FIG. 4F is a back view of the vehicle 400. The top spinning saw blade head attachment 405 includes a frame 410 and a saw blade appendage 415.

The frame 410 can include features adapted to secure the attachment 405 to the device 100. For example, the frame 410 can include vertical tabs 425 adapted to engage a surface of the notch 126 that separates the head from the body of the device 100 (see FIG. 1) to prevent unwanted movement of the attachment 405 in a forward direction (i.e., in a direction toward the nose 108 of the device 100). The frame 410 can also include horizontal tabs 430 adapted to engage the device 100 just under the head side surface 114 to prevent unwanted movement of the attachment 405 in an upward direction (i.e., in a direction away from a support surface 110 when the device 100 is upright). Essentially, the vertical tabs 425 and horizontal tabs 430 can allow the attachment 405 to snap into place on the device 100 and to be removed from the device 100 (e.g., using an amount of force greater than the device 100 experiences as a result of vibration during operation). The tabs 425 and 430, the frame 410, and/or the body 102 of the device 100 can be sufficiently flexible to deflect and/or deform, thereby allowing the attachment 405 to be fitted onto the device 100 and removed from the device 100 by a user. The frame 410 may be configured to conform to the shape of the nose sides 116a, 116b. As noted above, in some embodiments the frame can be connected (integrally or otherwise) to the device body 102 instead of being a separate and/or removable component.

The saw blade appendage 415 is rotatably coupled to the frame 410 of the top spinning saw blade head attachment 405 by an axle 435 that defines an axis of rotation for the spinning saw blade appendage 415.

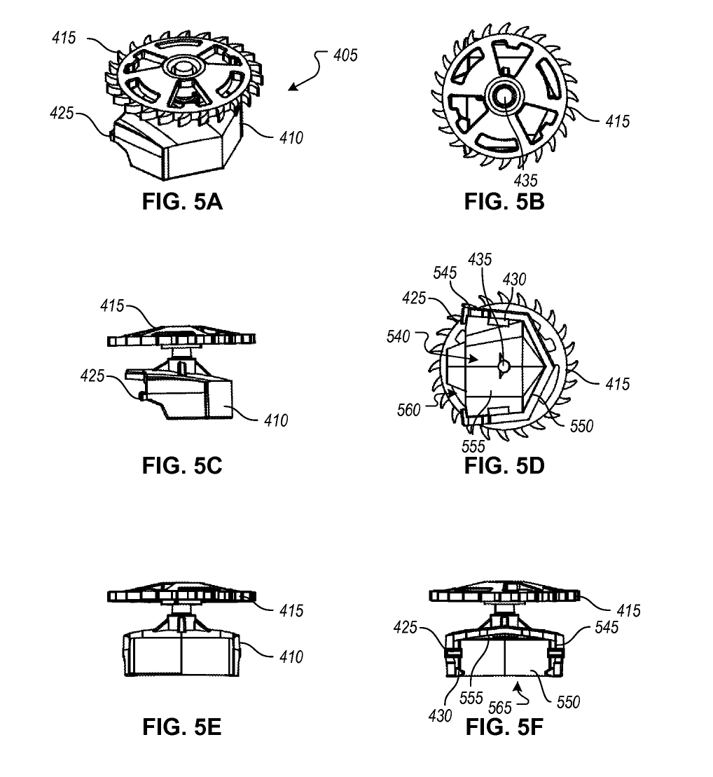

FIGS. 5A through 5F illustrate the top spinning saw blade head attachment 405 of FIGS. 4A-4F separate from the device 100. FIG. 5A is a perspective view of the top spinning saw blade head attachment 405, FIG. 5B is a top view of the top spinning saw blade head attachment 405, FIG. 5C is a side view of the top spinning saw blade head attachment 405, FIG. 5D is a bottom view of the top spinning saw blade head attachment 405, FIG. 5E is a front view of the top spinning saw blade head attachment 405, and FIG. 5F is a back view of the top spinning saw blade head attachment 405. FIGS. 5A-5F illustrate many of the same features as shown in FIGS. 4A-4F. In addition, FIGS. 5D and 5F illustrate additional details of a concave portion 540 of the top spinning saw blade head attachment 405 that fits onto the device 100. In this case, for example, the concave portion 540 is designed to substantially mate with a head portion of the device 100 of FIG. 1.

As shown in FIGS. 5D and 5F, the concave portion 540 is defined by sidewalls 545, a front wall 550, and a top wall 555. The sidewalls 545 of the concave portion 540 terminate at the rear of the frame 410 to define a rear opening 560 and at the bottom of the frame 410 to define a bottom opening 565. Using these openings, the device 100 can be inserted into the attachment 405 from the rear opening 560 or the bottom opening 565 (or a combination by inserting the device 100 at an angle). The sidewalls 545, front wall 550, and top wall 555 are illustrated as having a shape that generally conforms to the shape of the corresponding portion of the device 100. Thus, the internal dimensions may include surfaces that contact the corresponding portion of the device 100 sufficiently to secure the attachment 405 in place.

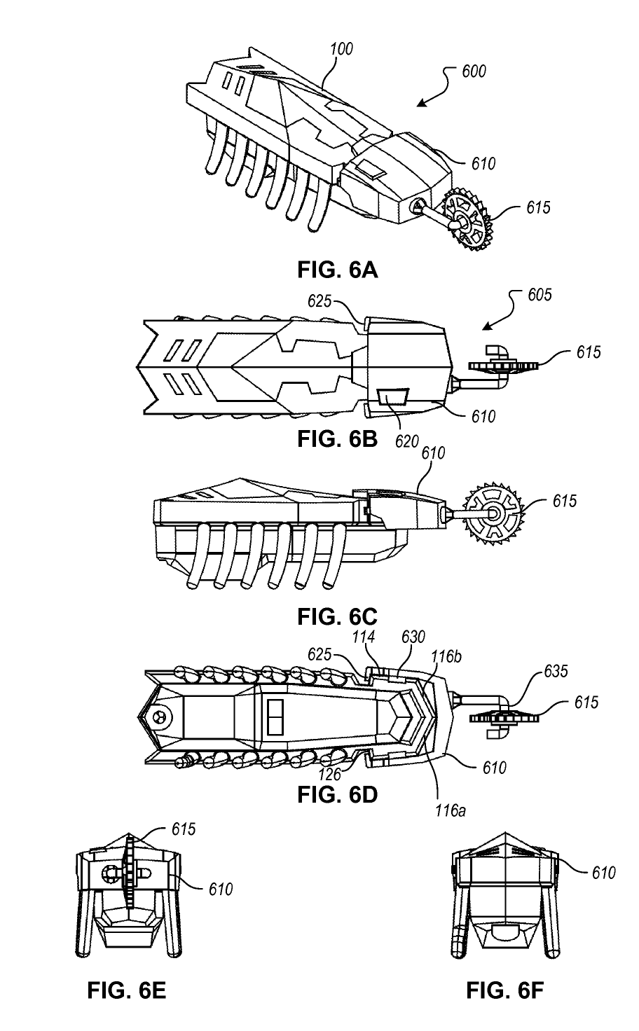

FIGS. 6A through 6F illustrate a vehicle 600 that includes a device 100 of FIG. 1 fitted with a front sideways spinning saw blade head attachment 605. FIG. 6A is a perspective view of the vehicle 600, FIG. 6B is a top view of the vehicle 600, FIG. 6C is a side view of the vehicle 600, FIG. 6D is a bottom view of the vehicle 600, FIG. 6E is a front view of the vehicle 600, and FIG. 6F is a back view of the vehicle 600. The front sideways spinning saw blade head attachment 605 includes a frame 610 and a sideways saw blade appendage 615. The frame 610 can include surface or three-dimensional ornamentation 620. Such ornamentation 620, in addition to providing aesthetic features, can provide an altered weight distribution of the vehicle 600 relative to the device 100 or relative to a vehicle similar to vehicle 600 that does not include the ornamentation 620. The altered weight distribution can counteract or otherwise alter motion tendencies induced by rotation of the appendage or can simply impact motion tendencies of the combined vehicle 600 as the device 100 vibrates.

The frame 610 can include features adapted to secure the attachment 605 to the device 100. For example, the frame 610 can include vertical tabs 625 adapted to engage a surface of the notch 126 that separates the head from the body of the device 100 (see FIG. 1) to prevent unwanted movement of the attachment 605 in a forward direction (i.e., in a direction toward the nose 108 of the device 100). The frame 610 can also include horizontal tabs 630 adapted to engage the device 100 just under the head side surface 114 to prevent unwanted movement of the attachment 605 in an upward direction (i.e., in a direction away from a support surface 110 when the device 100 is upright). Essentially, the vertical tabs 625 and horizontal tabs 630 can allow the attachment 605 to snap into place on the device 100 and to be removed from the device 100 (e.g., using an amount of force greater than the device 100 experiences as a result of vibration during operation). The tabs 625 and 630, the frame 610, and/or the body 102 of the device 100 can be sufficiently flexible to deflect and/or deform, thereby allowing the attachment 605 to be fitted onto the device 100 and removed from the device 100 by a user. The frame 610 may be configured to have at least a somewhat different internal shape than the shape of the device body 102 (e.g., the front portion of the frame 610 need not conform to the shape of nose sides 116a, 116b, although, in some embodiments, frame 610 can be configured to conform to the shape of the nose sides 116a, 116b). As noted above, in some embodiments the frame can be connected (integrally or otherwise) to the device body 102 instead of being a separate and/or removable component.

The sideways saw blade appendage 615 is rotatably coupled to the frame 610 of the front sideways spinning saw blade head attachment 605 by an axle 635 that defines an axis of rotation for the sideways spinning saw blade appendage 615. Other types of axles can also be used.

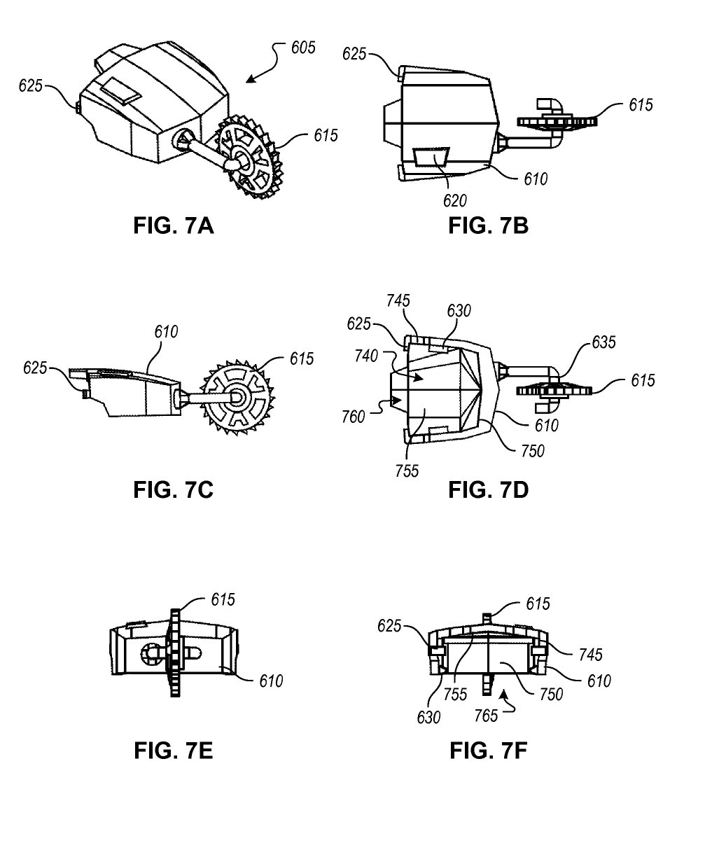

FIGS. 7A through 7F illustrate the front sideways spinning saw blade head attachment 605 of FIGS. 6A-6F separate from the device 100. FIG. 7A is a perspective view of the front sideways spinning saw blade head attachment 605, FIG. 7B is a top view of the front sideways spinning saw blade head attachment 605, FIG. 7C is a side view of the front sideways spinning saw blade head attachment 605, FIG. 7D is a bottom view of the front sideways spinning saw blade head attachment 605, FIG. 7E is a front view of the front sideways spinning saw blade head attachment 605, and FIG. 7F is a back view of the front sideways spinning saw blade head attachment 605. FIGS. 7A-7F illustrate many of the same features as shown in FIGS. 6A-6F. In addition, FIGS. 7D and 7F illustrate additional details of a concave portion 740 of the front sideways spinning saw blade head attachment 605 that fits onto the device 100. In this case, for example, the concave portion 740 is designed to substantially mate with a head portion of the device 100 of FIG. 1.

As shown in FIGS. 7D and 7F, the concave portion 740 is defined by sidewalls 745, a front wall 750, and a top wall 755. The sidewalls 745 of the concave portion 740 terminate at the rear of the frame 610 to define a rear opening 760 and at the bottom of the frame 610 to define a bottom opening 765. Using these openings, the device 100 can be inserted into the attachment 605 from the rear opening 760 or the bottom opening 765 (or a combination). The sidewalls 745 and top wall 755 are illustrated as having a shape that generally conforms to the shape of the corresponding portion of the device 100. The front wall 750 is illustrated as have a shape that does not conform to the nose portion 108, 116a, 116b of the device 100, although the front wall 750 may be designed to contact at least a portion of the nose 108 to provide a surface that opposes the vertical tabs 625. Thus, although the internal dimensions of the concave portion 740 may not conform precisely to the shape of a corresponding portion of the device 100, the internal dimensions may include surfaces that contact the corresponding portion of the device 100 sufficiently to secure the attachment 605 in place.

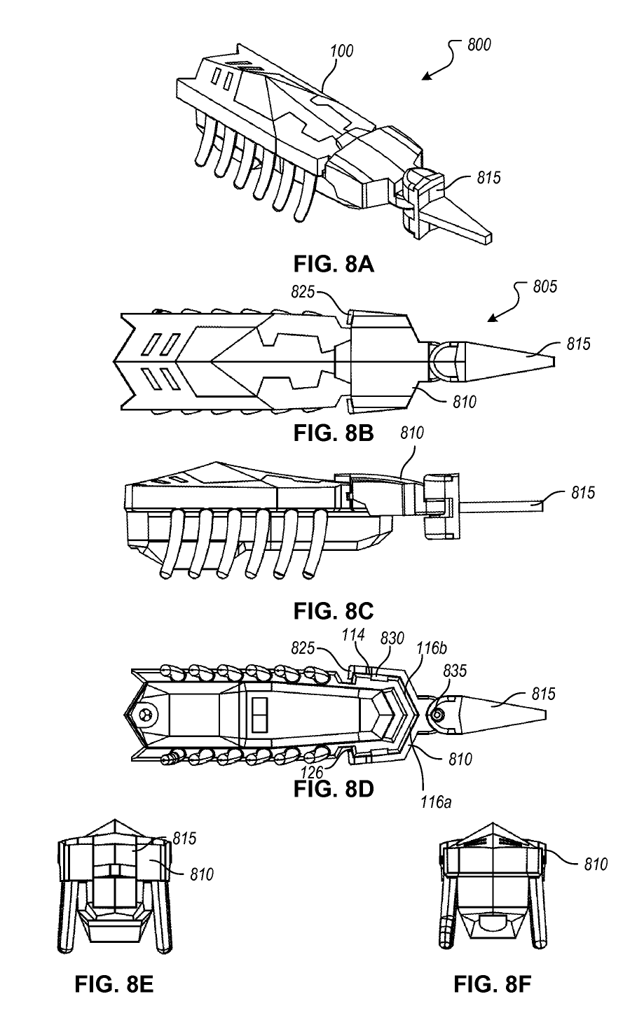

FIGS. 8A through 8F illustrate a vehicle 800 that includes a device 100 of FIG. 1 fitted with a front waving side-to-side blade attachment 805. FIG. 8A is a perspective view of the vehicle 800, FIG. 8B is a top view of the vehicle 800, FIG. 8C is a side view of the vehicle 800, FIG. 8D is a bottom view of the vehicle 800, FIG. 8E is a front view of the vehicle 800, and FIG. 8F is a back view of the vehicle 800. The front waving side-to-side blade attachment 805 includes a frame 810 and a waving blade appendage 815.

The frame 810 can include features adapted to secure the attachment 805 to the device 100. For example, the frame 810 can include vertical tabs 825 adapted to engage a surface of the notch 126 that separates the head from the body of the device 100 (see FIG. 1) to prevent unwanted movement of the attachment 805 in a forward direction (i.e., in a direction toward the nose 108 of the device 100). The frame 810 can also include horizontal tabs 830 adapted to engage the device 100 just under the head side surface 114 to prevent unwanted movement of the attachment 805 in an upward direction (i.e., in a direction away from a support surface 110 when the device 100 is upright). Essentially, the vertical tabs 825 and horizontal tabs 830 can allow the attachment 805 to snap into place on the device 100 and to be removed from the device 100 (e.g., using an amount of force greater than the device 100 experiences as a result of vibration during operation). The tabs 825 and 830, the frame 810, and/or the body 102 of the device 100 can be sufficiently flexible to deflect and/or deform, thereby allowing the attachment 805 to be fitted onto the device 100 and removed from the device 100 by a user. The frame 810 may be configured to conform to the shape of the nose sides 116a, 116b. As noted above, in some embodiments the frame can be connected (integrally or otherwise) to the device body 102 instead of being a separate and/or removable component.

The waving blade appendage 815 is rotatably coupled to the frame 810 of the front waving side-to-side blade attachment 805 by an axle 835 (e.g., a pin or screw) that defines an axis of rotation for the waving blade appendage 815.

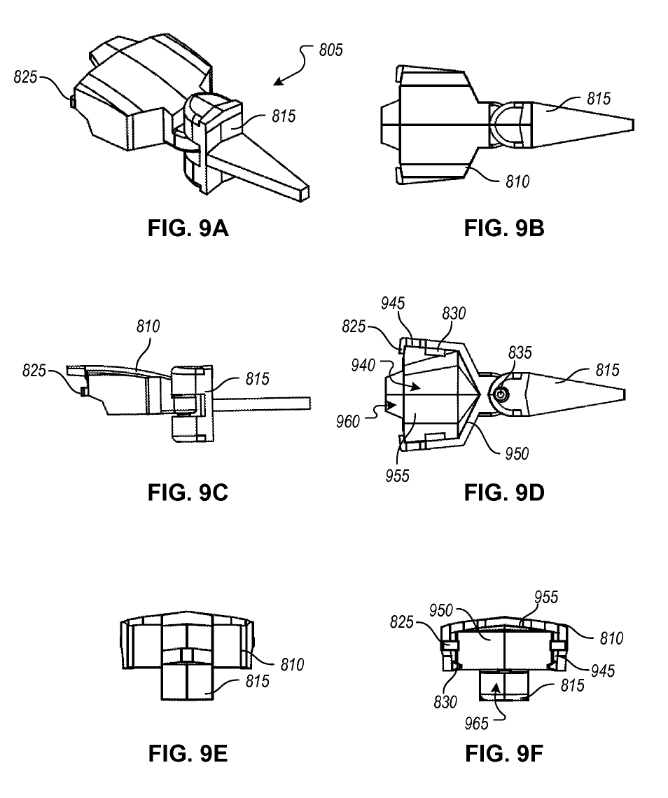

FIGS. 9A through 9F illustrate the front waving side-to-side blade attachment 805 of FIGS. 8A-8F separate from the device 100. FIG. 9A is a perspective view of the front waving side-to-side blade attachment 805, FIG. 9B is a top view of the front waving side-to-side blade attachment 805, FIG. 9C is a side view of the front waving side-to-side blade attachment 805, FIG. 9D is a bottom view of the front waving side-to-side blade attachment 805, FIG. 9E is a front view of the front waving side-to-side blade attachment 805, and FIG. 9F is a back view of the front waving side-to-side blade attachment 805. FIGS. 9A-9F illustrate many of the same features as shown in FIGS. 8A-8F. In addition, FIGS. 9D and 9F illustrate additional details of a concave portion 940 of the front waving side-to-side blade attachment 805 that fits onto the device 100. In this case, for example, the concave portion 940 is designed to substantially mate with a head portion of the device 100 of FIG. 1.

As shown in FIGS. 9D and 9F, the concave portion 940 is defined by sidewalls 945, a front wall 950, and a top wall 955. The sidewalls 945 of the concave portion 940 terminate at the rear of the frame 810 to define a rear opening 960 and at the bottom of the frame 810 to define a bottom opening 965. Using these openings, the device 100 can be inserted into the attachment 805 from the rear opening 960 or the bottom opening 965 (or a combination by inserting the device 100 at an angle). The sidewalls 945, front wall 950, and top wall 955 are illustrated as having a shape that generally conforms to the shape of the corresponding portion of the device 100. Thus, the internal dimensions may include surfaces that contact the corresponding portion of the device 100 sufficiently to secure the attachment 805 in place.

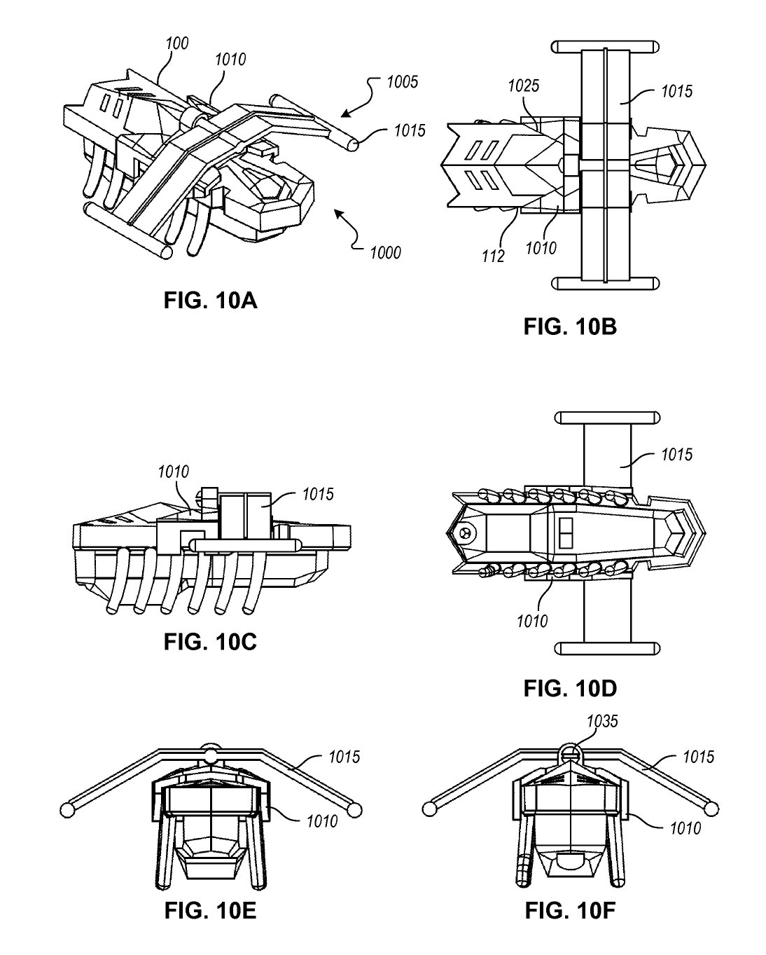

FIGS. 10A through 10F illustrate a vehicle 1000 that includes a device 100 of FIG. 1 fitted with a rocking wing body attachment 1005. FIG. 10A is a perspective view of the vehicle 1000, FIG. 10B is a top view of the vehicle 1000, FIG. 10C is a side view of the vehicle 1000, FIG. 10D is a bottom view of the vehicle 1000, FIG. 10E is a front view of the vehicle 1000, and FIG. 10F is a back view of the vehicle 1000. The rocking wing body attachment 1005 includes a frame 1010 and a rocking wing appendage 1015.

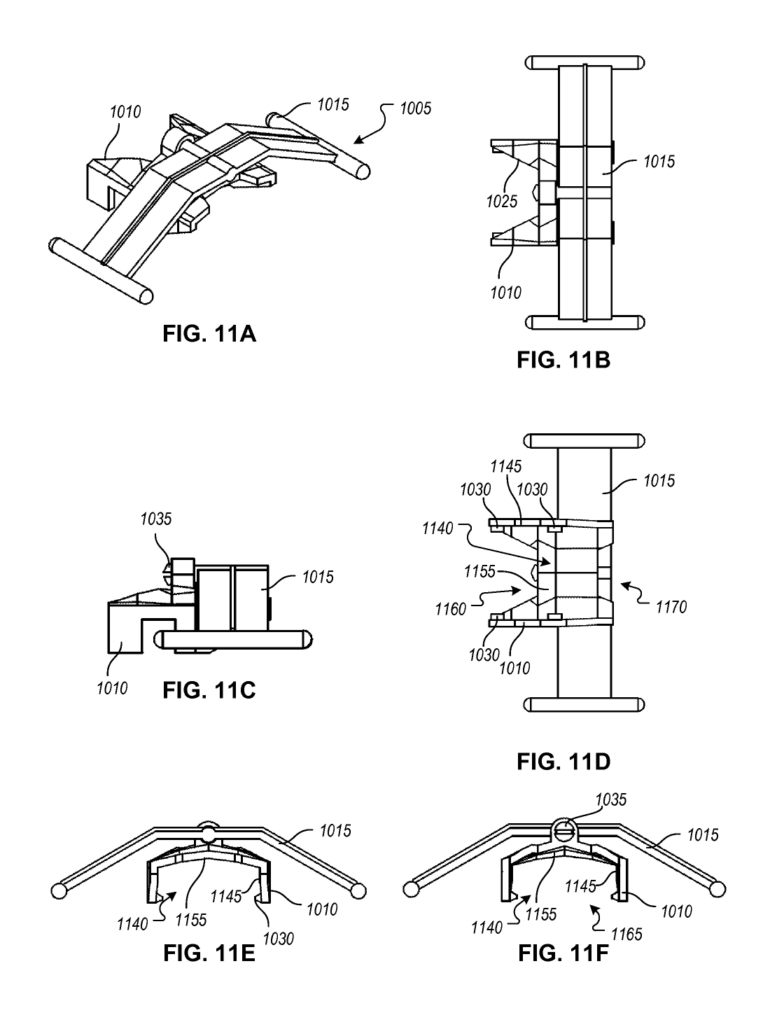

The frame 1010 can include features adapted to secure the attachment 1005 to the device 100. For example, the frame 1010 can include horizontal tabs 1030 (see, e.g., FIG. 11D) adapted to engage the device 100 just under the body shoulder 112 to prevent unwanted movement of the attachment 1005 in an upward direction (i.e., in a direction away from a support surface 110 when the device 100 is upright). In addition, the shape of the frame (at 1025 and 1155) can encourage mating between the frame 1010 and the body 102 of the device 100 at a particular location along the length of the body 102. Essentially, the frame shape and horizontal tabs 1030 can allow the attachment 1005 to snap into place on the device 100 and to be removed from the device 100 (e.g., using an amount of force greater than the device 100 experiences as a result of vibration during operation). The tabs 1030, the frame 1010, and/or the body 102 of the device 100 can be sufficiently flexible to deflect and/or deform, thereby allowing the attachment 1005 to be fitted onto the device 100 and removed from the device 100 by a user. As noted above, in some embodiments the frame can be connected (integrally or otherwise) to the device body 102 instead of being a separate and/or removable component.

The rocking wing appendage 1015 is rotatably coupled to the frame 1010 of the rocking wing body attachment 1005 by an axle 1035 (e.g., a pin or screw) that defines an axis of rotation for the rocking wing appendage 1015.

FIGS. 11A through 11F illustrate the rocking wing body attachment 1005 of FIGS. 10A-10F separate from the device 100. FIG. 11A is a perspective view of the rocking wing body attachment 1005, FIG. 11B is a top view of the rocking wing body attachment 1005, FIG. 11C is a side view of the rocking wing body attachment 1005, FIG. 11D is a bottom view of the rocking wing body attachment 1005, FIG. 11E is a front view of the rocking wing body attachment 1005, and FIG. 11F is a back view of the rocking wing body attachment 1005. FIGS. 11A-11F illustrate many of the same features as shown in FIGS. 10A-10F. In addition, FIGS. 11D-11F illustrate additional details of a concave portion 1140 of the rocking wing body attachment 1005 that fits onto the device 100. In this case, for example, the concave portion 1140 is designed to substantially mate with a middle body portion of the device 100 of FIG. 1.

As shown in FIGS. 11D-11F, the concave portion 1140 is defined by sidewalls 1145 and a top wall 1155. The sidewalls 1145 of the concave portion 1140 terminate at the rear of the frame 1010 to define a rear opening 1160, at the bottom of the frame 1010 to define a bottom opening 1165, and at the front of the frame 1010 to define a front opening 1170. Using these openings, the device 100 can be inserted into the attachment 1005 from the rear opening 1160, the bottom opening 1165, or the front opening 1170 (or a combination by inserting the device 100 at an angle). The sidewalls 1145 and top wall 1155 are illustrated as having a shape that generally conforms to the shape of the corresponding portion of the device 100. Thus, the internal dimensions may include surfaces that contact the corresponding portion of the device 100 sufficiently to secure the attachment 1005 in place.

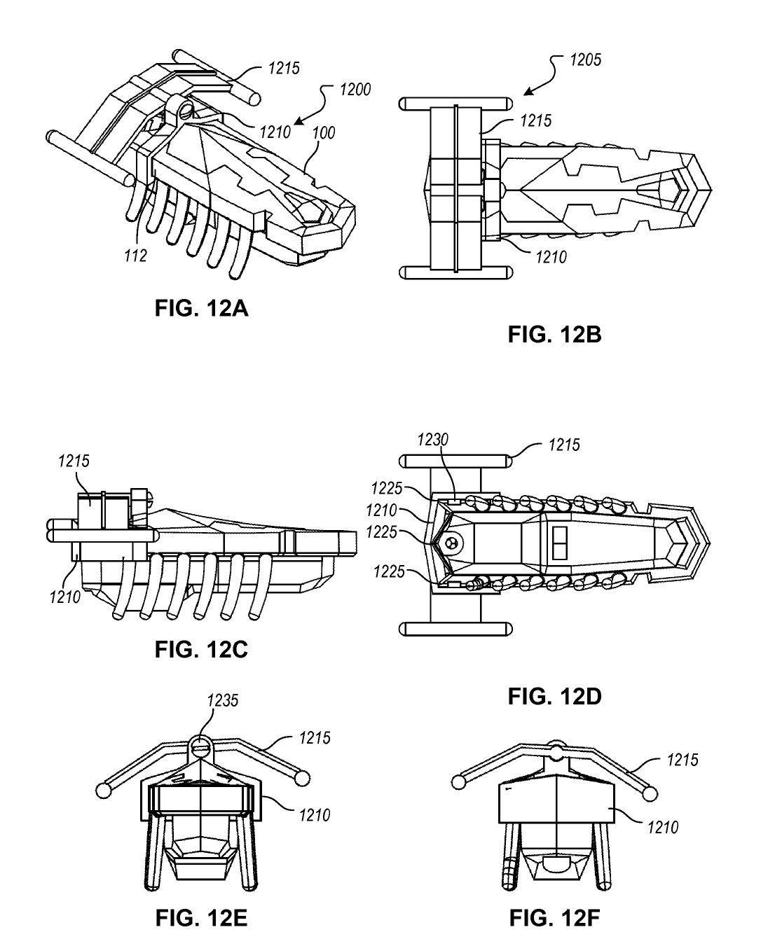

FIGS. 12A through 12F illustrate a vehicle 1200 that includes a device 100 of FIG. 1 fitted with a rocking wing tail attachment 1205. FIG. 12A is a perspective view of the vehicle 1200, FIG. 12B is a top view of the vehicle 1200, FIG. 12C is a side view of the vehicle 1200, FIG. 12D is a bottom view of the vehicle 1200, FIG. 12E is a front view of the vehicle 1200, and FIG. 12F is a back view of the vehicle 1200. The rocking wing tail attachment 1205 includes a frame 1210 and a rocking wing appendage 1215.

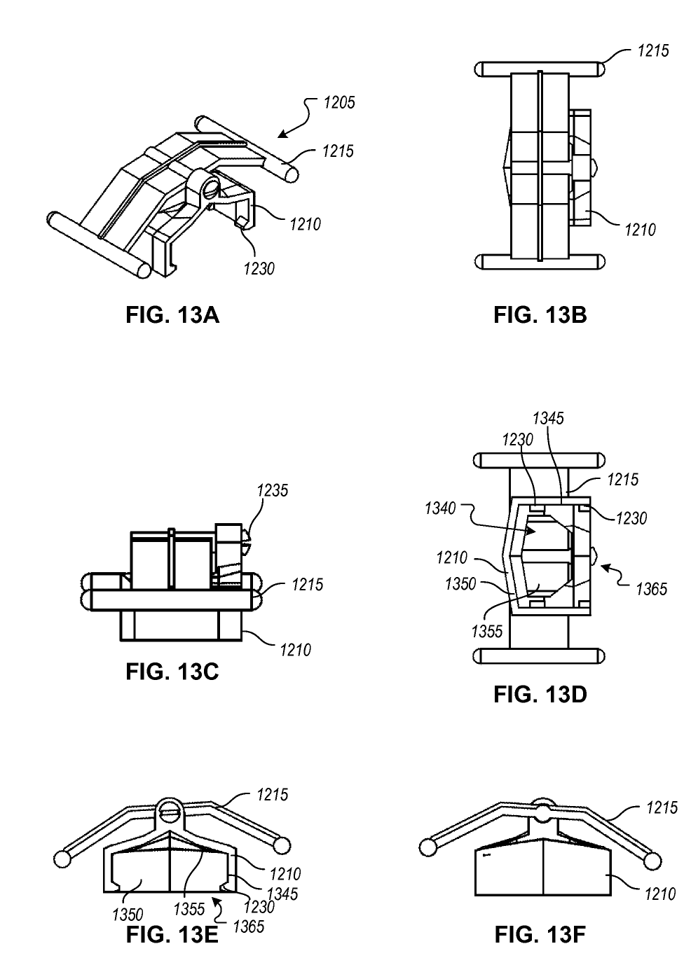

The frame 1210 can include features adapted to secure the attachment 1205 to the device 100. For example, the frame 1210 can include engage the tail end of the device 100 at contact points 1225. The frame 1210 can also include horizontal tabs 1230 adapted to engage the device 100 just under the body shoulders 112 to prevent unwanted movement of the attachment 1205 in an upward direction (i.e., in a direction away from a support surface 110 when the device 100 is upright). Essentially, the contact points 1225 and horizontal tabs 1230 (along with the shape of the internal top wall 1355 shown in FIG. 13E) can allow the attachment 1205 to snap into place on the device 100 and to be removed from the device 100 (e.g., using an amount of force greater than the device 100 experiences as a result of vibration during operation). The tabs 1230, the frame 1210, and/or the body 102 of the device 100 can be sufficiently flexible to deflect and/or deform, thereby allowing the attachment 1205 to be fitted onto the device 100 and removed from the device 100 by a user. The frame 1210 may be configured to have at least a somewhat different internal shape than the shape of the device body 102 (e.g., the back portion of the frame 1210 need not conform to the shape of tail end of the device 100, although, in some embodiments, frame 1210 can be configured to conform to the shape of the device tail). As noted above, in some embodiments the frame can be connected (integrally or otherwise) to the device body 102 instead of being a separate and/or removable component.

The rocking wing appendage 1215 is rotatably coupled to the frame 1210 of the rocking wing tail attachment 1205 by a screw 1235 that serves as an axle and defines an axis of rotation for the rocking wing appendage 1215. Although the attachment 1205 is illustrated as using a screw 1235, other types of axles (e.g., a rod that projects from the frame that mates with a hollow cylinder of the appendage 1215) can also be used. Moreover, the axle can be fixedly attached to either the frame 1210 or the appendage 1215, or neither.

FIGS. 13A through 13F illustrate the rocking wing tail attachment 1205 of FIGS. 12A-12F separate from the device 100. FIG. 13A is a perspective view of the rocking wing tail attachment 1205, FIG. 13B is a top view of the rocking wing tail attachment 1205, FIG. 13C is a side view of the rocking wing tail attachment 1205, FIG. 13D is a bottom view of the rocking wing tail attachment 1205, FIG. 13E is a front view of the rocking wing tail attachment 1205, and FIG. 13F is a back view of the rocking wing tail attachment 1205. FIGS. 13A-13F illustrate many of the same features as shown in FIGS. 12A-12F. In addition, FIGS. 13D and 13E illustrate additional details of a concave portion 1340 of the rocking wing tail attachment 1205 that fits onto the device 100. In this case, for example, the concave portion 1340 is designed to substantially mate with a tail portion of the device 100 of FIG. 1.

As shown in FIGS. 13D and 13E, the concave portion 1340 is defined by sidewalls 1345, a back wall 1350, and a top wall 1355. The sidewalls 1345 of the concave portion 1340 terminate at the front of the frame 1210 to define a front opening 1370 and at the bottom of the frame 1210 to define a bottom opening 1365. Using these openings, the device 100 can be inserted into the attachment 1205 from the front opening 1370 or the bottom opening 1365 (or a combination). The sidewalls 1345 and top wall 1355 are illustrated as having a shape that generally conforms to the shape of the corresponding portion of the device 100. The back wall 1350 is illustrated as have a shape that does not conform to the tail portion of the device 100, although the back wall 1350 may be designed to contact the device at contact surfaces 1225 (see FIG. 12D). Thus, although the internal dimensions of the concave portion 1340 may not conform precisely to the shape of a corresponding portion of the device 100, the internal dimensions may include surfaces that contact the corresponding portion of the device 100 sufficiently to secure the attachment 1205 in place.

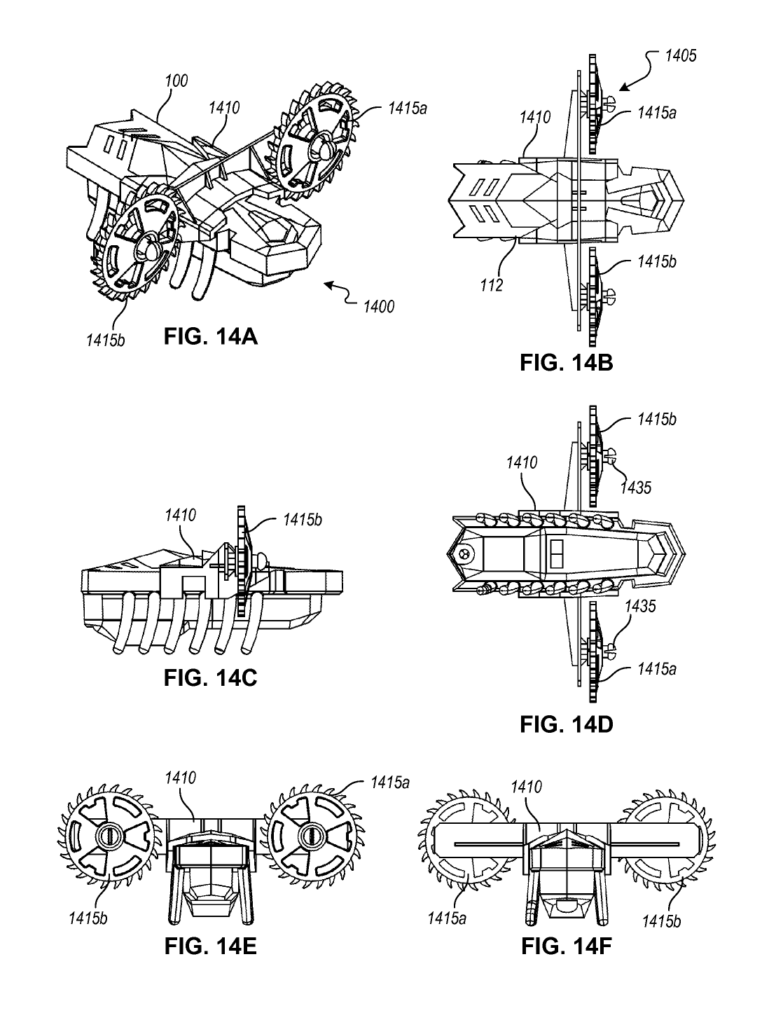

FIGS. 14A through 14F illustrate a vehicle 1400 that includes a device 100 of FIG. 1 fitted with a dual side saw blades attachment 1405. FIG. 14A is a perspective view of the vehicle 1400, FIG. 14B is a top view of the vehicle 1400, FIG. 14C is a side view of the vehicle 1400, FIG. 14D is a bottom view of the vehicle 1400, FIG. 14E is a front view of the vehicle 1400, and FIG. 14F is a back view of the vehicle 1400. The dual side saw blades attachment 1405 includes a frame 1410 and saw blade appendages 1415.

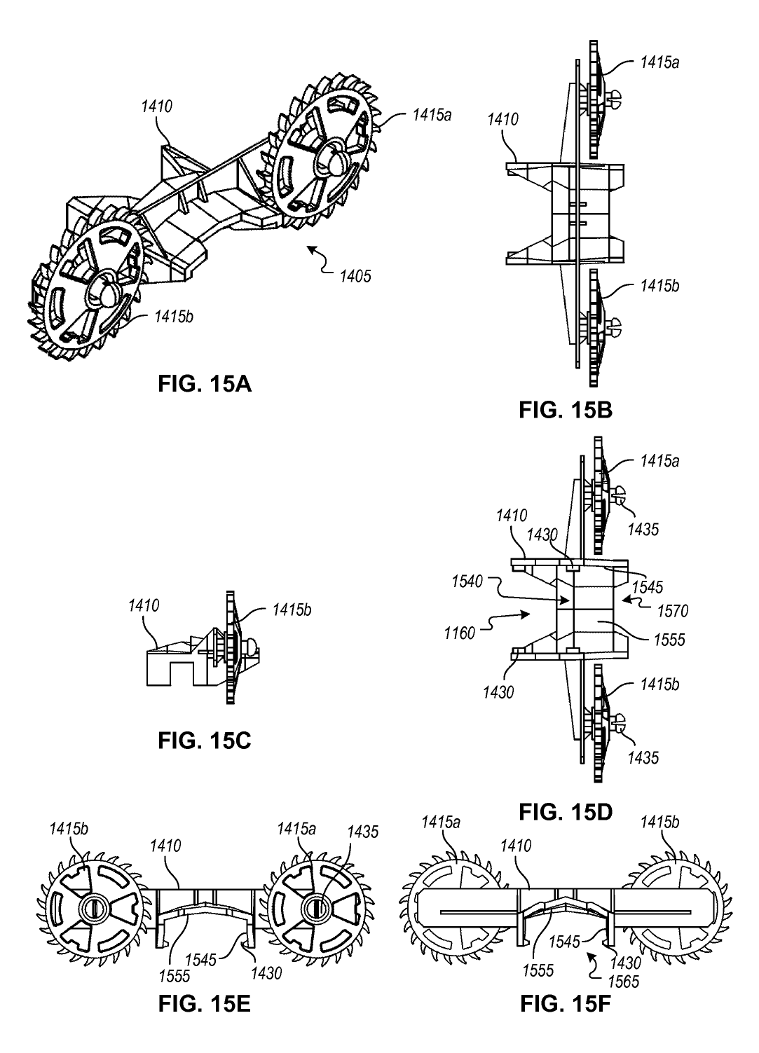

The frame 1410 can include features adapted to secure the attachment 1405 to the device 100. For example, the frame 1410 can include horizontal tabs 1430 (see, e.g., FIG. 15D) adapted to engage the device 100 just under the body shoulder 112 to prevent unwanted movement of the attachment 1405 in an upward direction (i.e., in a direction away from a support surface 110 when the device 100 is upright). In addition, the shape of the frame (at 1555) can encourage mating between the frame 1410 and the body 102 of the device 100 at a particular location along the length of the body 102. Essentially, the frame shape and horizontal tabs 1430 can allow the attachment 1405 to snap into place on the device 100 and to be removed from the device 100 (e.g., using an amount of force greater than the device 100 experiences as a result of vibration during operation). The tabs 1430, the frame 1410, and/or the body 102 of the device 100 can be sufficiently flexible to deflect and/or deform, thereby allowing the attachment 1405 to be fitted onto the device 100 and removed from the device 100 by a user. As noted above, in some embodiments the frame can be connected (integrally or otherwise) to the device body 102 instead of being a separate and/or removable component.

The saw blade appendages 1415 are rotatably coupled to the frame 1410 of the dual side saw blades attachment 1405 by axles 1435 (e.g., a pin or screw) that define respective axes of rotation for the saw blade appendages 1415.

FIGS. 15A through 15F illustrate the dual side saw blades attachment 1405 of FIGS. 14A-14F separate from the device 100. FIG. 15A is a perspective view of the dual side saw blades attachment 1405, FIG. 15B is a top view of the dual side saw blades attachment 1405, FIG. 15C is a side view of the dual side saw blades attachment 1405, FIG. 15D is a bottom view of the dual side saw blades attachment 1405, FIG. 15E is a front view of the dual side saw blades attachment 1405, and FIG. 15F is a back view of the dual side saw blades attachment 1405. FIGS. 15A-15F illustrate many of the same features as shown in FIGS. 14A-14F. In addition, FIGS. 15D-15F illustrate additional details of a concave portion 1540 of the dual side saw blades attachment 1405 that fits onto the device 100. In this case, for example, the concave portion 1540 is designed to substantially mate with a middle body portion of the device 100 of FIG. 1.

As shown in FIGS. 15D-15F, the concave portion 1540 is defined by sidewalls 1545 and a top wall 1555. The sidewalls 1545 of the concave portion 1540 terminate at the rear of the frame 1410 to define a rear opening 1560, at the bottom of the frame 1410 to define a bottom opening 1565, and at the front of the frame 1410 to define a front opening 1570. Using these openings, the device 100 can be inserted into the attachment 1405 from the rear opening 1560, the bottom opening 1565, or the front opening 1570 (or a combination by inserting the device 100 at an angle). The sidewalls 1545 and top wall 1555 are illustrated as having a shape that generally conforms to the shape of the corresponding portion of the device 100. Thus, the internal dimensions may include surfaces that contact the corresponding portion of the device 100 sufficiently to secure the attachment 1405 in place.

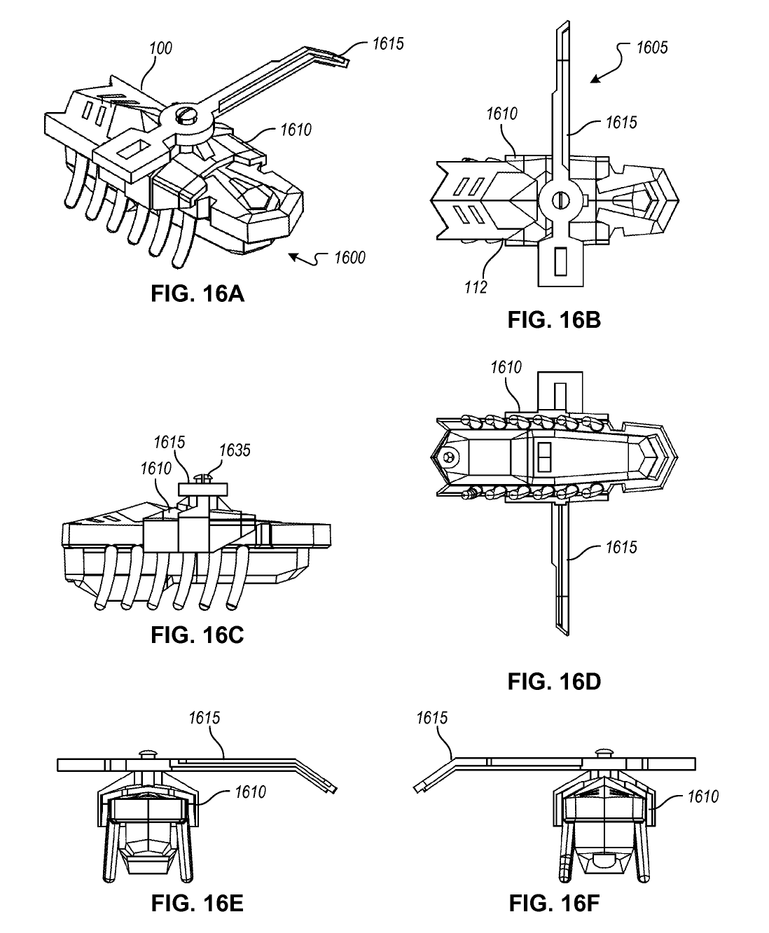

FIGS. 16A through 16F illustrate a vehicle 1600 that includes a device 100 of FIG. 1 fitted with a spinning top blade body attachment 1605. FIG. 16A is a perspective view of the vehicle 1600, FIG. 16B is a top view of the vehicle 1600, FIG. 16C is a side view of the vehicle 1600, FIG. 16D is a bottom view of the vehicle 1600, FIG. 16E is a front view of the vehicle 1600, and FIG. 16F is a back view of the vehicle 1600. The spinning top blade body attachment 1605 includes a frame 1610 and a spinning blade appendage 1615.

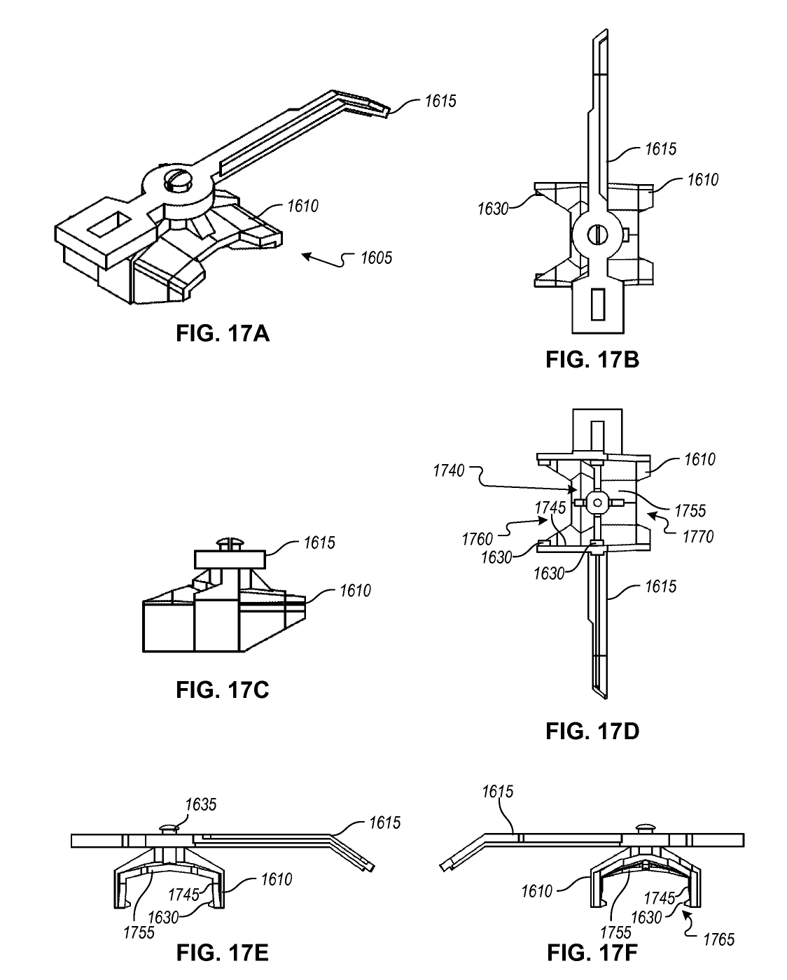

The frame 1610 can include features adapted to secure the attachment 1605 to the device 100. For example, the frame 1610 can include horizontal tabs 1630 (see, e.g., FIG. 17D) adapted to engage the device 100 just under the body shoulder 112 to prevent unwanted movement of the attachment 1605 in an upward direction (i.e., in a direction away from a support surface 110 when the device 100 is upright). In addition, the shape of the frame (at 1755) can encourage mating between the frame 1610 and the body 102 of the device 100 at a particular location along the length of the body 102. Essentially, the frame shape and horizontal tabs 1630 can allow the attachment 1605 to snap into place on the device 100 and to be removed from the device 100 (e.g., using an amount of force greater than the device 100 experiences as a result of vibration during operation). The tabs 1630, the frame 1610, and/or the body 102 of the device 100 can be sufficiently flexible to deflect and/or deform, thereby allowing the attachment 1605 to be fitted onto the device 100 and removed from the device 100 by a user. As noted above, in some embodiments the frame can be connected (integrally or otherwise) to the device body 102 instead of being a separate and/or removable component.

The spinning blade appendage 1615 is rotatably coupled to the frame 1610 of the spinning top blade body attachment 1605 by an axle 1635 (e.g., a pin or screw) that defines an axis of rotation for the spinning blade appendage 1615.

FIGS. 17A through 17F illustrate the spinning top blade body attachment 1605 of FIGS. 16A-16F separate from the device 100. FIG. 17A is a perspective view of the spinning top blade body attachment 1605, FIG. 17B is a top view of the spinning top blade body attachment 1605, FIG. 17C is a side view of the spinning top blade body attachment 1605, FIG. 17D is a bottom view of the spinning top blade body attachment 1605, FIG. 17E is a front view of the spinning top blade body attachment 1605, and FIG. 17F is a back view of the spinning top blade body attachment 1605. FIGS. 17A-17F illustrate many of the same features as shown in FIGS. 16A-16F. In addition, FIGS. 17D-17F illustrate additional details of a concave portion 1740 of the spinning top blade body attachment 1605 that fits onto the device 100. In this case, for example, the concave portion 1740 is designed to substantially mate with a middle body portion of the device 100 of FIG. 1.

As shown in FIGS. 17D-17F, the concave portion 1740 is defined by sidewalls 1745 and a top wall 1755. The sidewalls 1745 of the concave portion 1740 terminate at the rear of the frame 1610 to define a rear opening 1760, at the bottom of the frame 1610 to define a bottom opening 1765, and at the front of the frame 1610 to define a front opening 1770. Using these openings, the device 100 can be inserted into the attachment 1605 from the rear opening 1760, the bottom opening 1765, or the front opening 1770 (or a combination by inserting the device 100 at an angle). The sidewalls 1745 and top wall 1755 are illustrated as having a shape that generally conforms to the shape of the corresponding portion of the device 100. Thus, the internal dimensions may include surfaces that contact the corresponding portion of the device 100 sufficiently to secure the attachment 1605 in place.

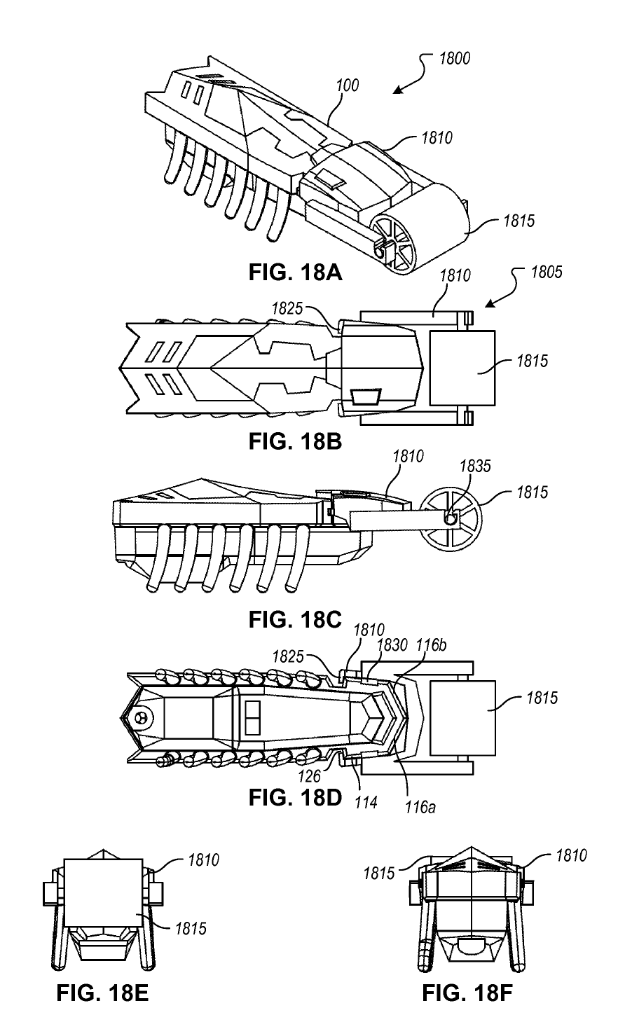

FIGS. 18A through 18F illustrate a vehicle 1800 that includes a device 100 of FIG. 1 fitted with a front rotating drum attachment 1805. FIG. 18A is a perspective view of the vehicle 1800, FIG. 18B is a top view of the vehicle 1800, FIG. 18C is a side view of the vehicle 1800, FIG. 18D is a bottom view of the vehicle 1800, FIG. 18E is a front view of the vehicle 1800, and FIG. 18F is a back view of the vehicle 1800. The front rotating drum attachment 1805 includes a frame 1810 and a rotating drum appendage 1815. The frame 1810 can include surface or three-dimensional ornamentation 1820. Such ornamentation 1820, in addition to providing aesthetic features, can provide an altered weight distribution of the vehicle 1800 relative to the device 100 or relative to a vehicle similar to vehicle 1800 that does not include the ornamentation 1820. The altered weight distribution can counteract or otherwise alter motion tendencies induced by rotation of the appendage or can simply impact motion tendencies of the combined vehicle 1800 as the device 100 vibrates.

The frame 1810 can include features adapted to secure the attachment 1805 to the device 100. For example, the frame 1810 can include vertical tabs 1825 adapted to engage a surface of the notch 126 that separates the head from the body of the device 100 (see FIG. 1) to prevent unwanted movement of the attachment 1805 in a forward direction (i.e., in a direction toward the nose 108 of the device 100). The frame 1810 can also include horizontal tabs 1830 adapted to engage the device 100 just under the head side surface 114 to prevent unwanted movement of the attachment 1805 in an upward direction (i.e., in a direction away from a support surface 110 when the device 100 is upright). Essentially, the vertical tabs 1825 and horizontal tabs 1830 can allow the attachment 1805 to snap into place on the device 100 and to be removed from the device 100 (e.g., using an amount of force greater than the device 100 experiences as a result of vibration during operation). The tabs 1825 and 1830, the frame 1810, and/or the body 102 of the device 100 can be sufficiently flexible to deflect and/or deform, thereby allowing the attachment 1805 to be fitted onto the device 100 and removed from the device 100 by a user. The frame 1810 may be configured to have at least a somewhat different internal shape than the shape of the device body 102 (e.g., the front portion of the frame 1810 need not conform to the shape of nose sides 116a, 116b, although, in some embodiments, frame 1810 can be configured to conform to the shape of the nose sides 116a, 116b). As noted above, in some embodiments the frame can be connected (integrally or otherwise) to the device body 102 instead of being a separate and/or removable component.

The rotating drum appendage 1815 is rotatably coupled to the frame 1810 of the front rotating drum attachment 1805 by an axle 1835 that defines an axis of rotation for the rotating drum appendage 1815. Various types of axles can be used.

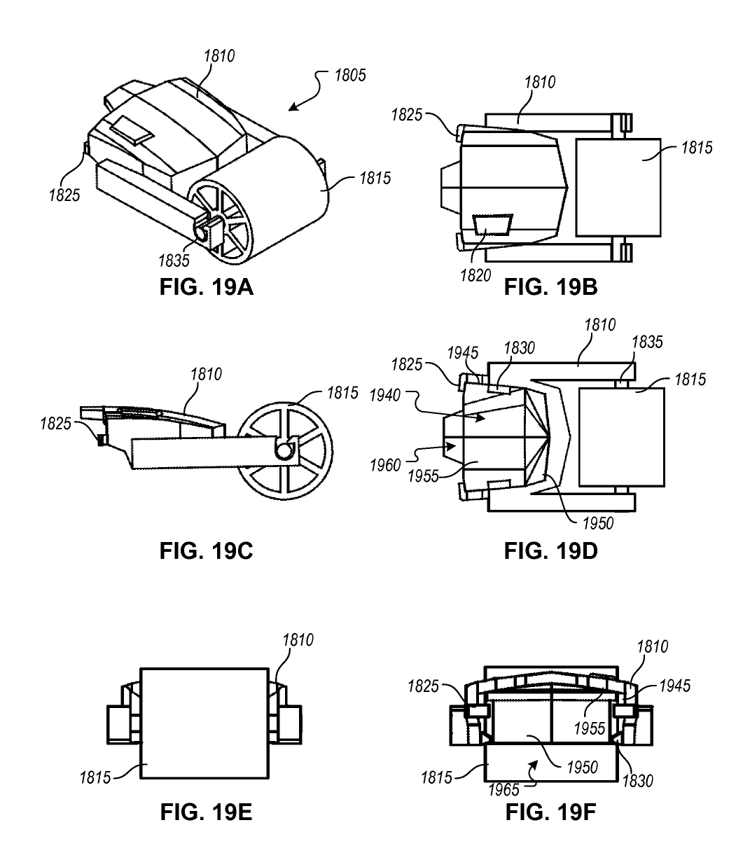

FIGS. 19A through 19F illustrate the front rotating drum attachment 1805 of FIGS. 18A-18F separate from the device 100. FIG. 19A is a perspective view of the front rotating drum attachment 1805, FIG. 19B is a top view of the front rotating drum attachment 1805, FIG. 19C is a side view of the front rotating drum attachment 1805, FIG. 19D is a bottom view of the front rotating drum attachment 1805, FIG. 19E is a front view of the front rotating drum attachment 1805, and FIG. 19F is a back view of the front rotating drum attachment 1805. FIGS. 19A-19F illustrate many of the same features as shown in FIGS. 18A-18F. In addition, FIGS. 19D and 19F illustrate additional details of a concave portion 1940 of the front rotating drum attachment 1805 that fits onto the device 100. In this case, for example, the concave portion 1940 is designed to substantially mate with a head portion of the device 100 of FIG. 1.

As shown in FIGS. 19D and 19F, the concave portion 1940 is defined by sidewalls 1945, a front wall 1950, and a top wall 1955. The sidewalls 1945 of the concave portion 1940 terminate at the rear of the frame 1810 to define a rear opening 1960 and at the bottom of the frame 1810 to define a bottom opening 1965. Using these openings, the device 100 can be inserted into the attachment 1805 from the rear opening 1960 or the bottom opening 1965 (or a combination). The sidewalls 1945 and top wall 1955 are illustrated as having a shape that generally conforms to the shape of the corresponding portion of the device 100. The front wall 1950 is illustrated as have a shape that does not conform to the nose portion 108, 116a, 116b of the device 100, although the front wall 1950 may be designed to contact at least a portion of the nose 108 to provide a surface that opposes the vertical tabs 1825. Thus, although the internal dimensions of the concave portion 1940 may not conform precisely to the shape of a corresponding portion of the device 100, the internal dimensions may include surfaces that contact the corresponding portion of the device 100 sufficiently to secure the attachment 1805 in place.

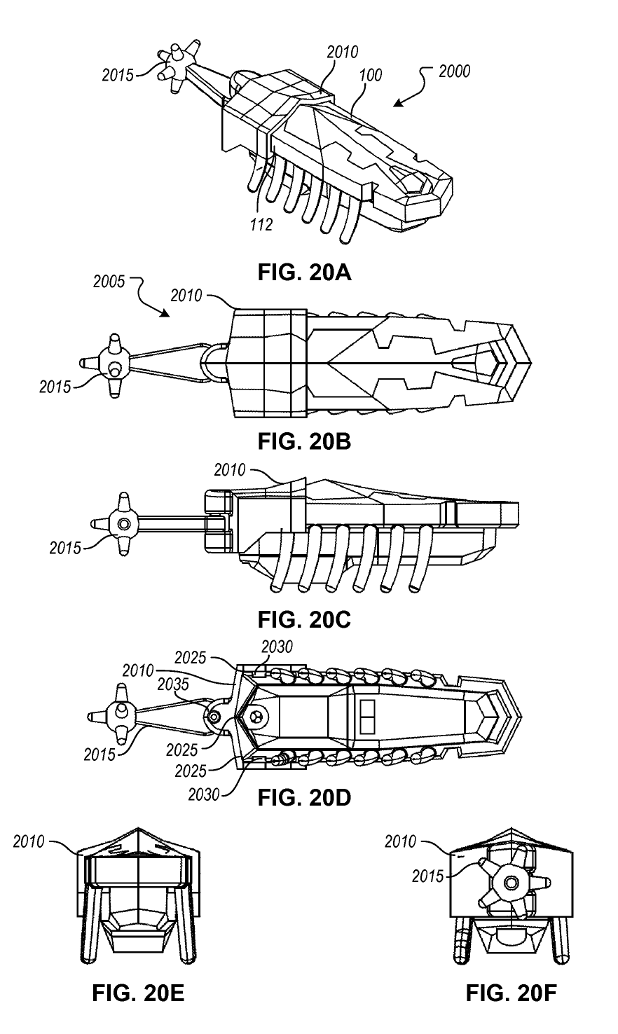

FIGS. 20A through 20F illustrate a vehicle 2000 that includes a device 100 of FIG. 1 fitted with a side-to-side waving tail attachment 2005. FIG. 20A is a perspective view of the vehicle 2000, FIG. 20B is a top view of the vehicle 2000, FIG. 20C is a side view of the vehicle 2000, FIG. 20D is a bottom view of the vehicle 2000, FIG. 20E is a front view of the vehicle 2000, and FIG. 20F is a back view of the vehicle 2000. The side-to-side waving tail attachment 2005 includes a frame 2010 and a waving tail appendage 2015.

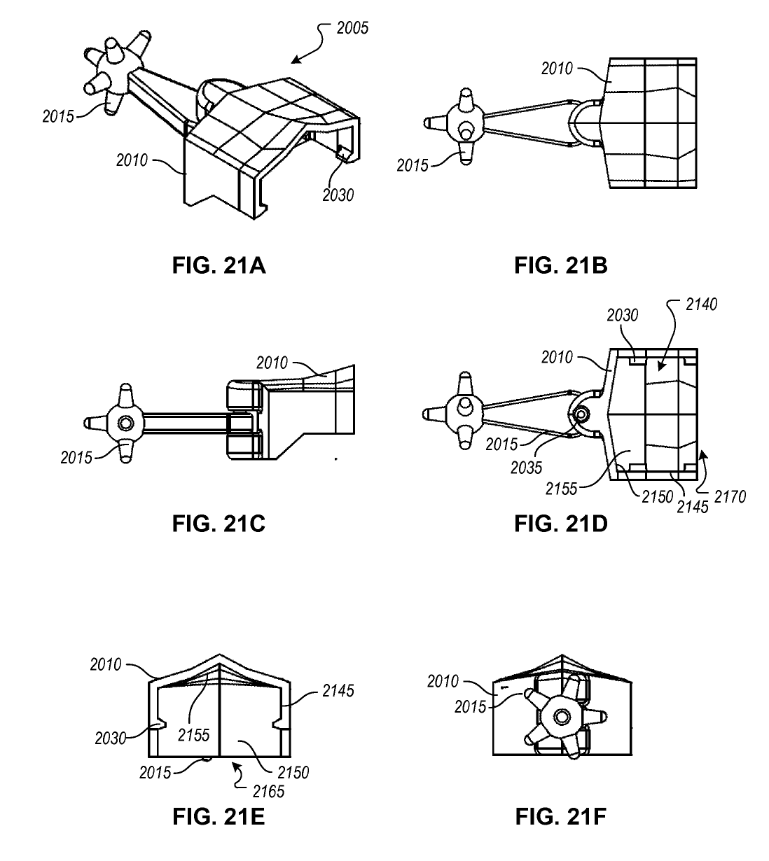

The frame 2010 can include features adapted to secure the attachment 2005 to the device 100. For example, the frame 2010 can include engage the tail end of the device 100 at contact points 2025. The frame 2010 can also include horizontal tabs 2030 adapted to engage the device 100 just under the body shoulders 112 to prevent unwanted movement of the attachment 2005 in an upward direction (i.e., in a direction away from a support surface 110 when the device 100 is upright). Essentially, the contact points 2025 and horizontal tabs 2030 (along with the shape of the internal top wall 2155 shown in FIG. 21E) can allow the attachment 2005 to snap into place on the device 100 and to be removed from the device 100 (e.g., using an amount of force greater than the device 100 experiences as a result of vibration during operation). The tabs 2030, the frame 2010, and/or the body 102 of the device 100 can be sufficiently flexible to deflect and/or deform, thereby allowing the attachment 2005 to be fitted onto the device 100 and removed from the device 100 by a user. The frame 2010 may be configured to have at least a somewhat different internal shape than the shape of the device body 102 (e.g., the back portion of the frame 2010 need not conform to the shape of tail end of the device 100, although, in some embodiments, frame 2010 can be configured to conform to the shape of the device tail). As noted above, in some embodiments the frame can be connected (integrally or otherwise) to the device body 102 instead of being a separate and/or removable component.

The waving tail appendage 2015 is rotatably coupled to the frame 2010 of the side-to-side waving tail attachment 2005 by a screw 2035 that serves as an axle and defines an axis of rotation for the waving tail appendage 2015. Although the attachment 2005 is illustrated as using a screw 2035, other types of axles (e.g., a rod that projects from the frame that mates with a hollow cylinder of the appendage 2015) can also be used. Moreover, the axle can be fixedly attached to either the frame 2010 or the appendage 2015, or neither.

FIGS. 21A through 21F illustrate the side-to-side waving tail attachment 2005 of FIG. 20 separate from the device 100. FIG. 21A is a perspective view of the side-to-side waving tail attachment 2005, FIG. 21B is a top view of the side-to-side waving tail attachment 2005, FIG. 21C is a side view of the side-to-side waving tail attachment 2005, FIG. 21D is a bottom view of the side-to-side waving tail attachment 2005, FIG. 21E is a front view of the side-to-side waving tail attachment 2005, and FIG. 21F is a back view of the side-to-side waving tail attachment 2005. FIGS. 21A-21F illustrate many of the same features as shown in FIGS. 20A-20F. In addition, FIGS. 21D and 21E illustrate additional details of a concave portion 2140 of the side-to-side waving tail attachment 2005 that fits onto the device 100. In this case, for example, the concave portion 2140 is designed to substantially mate with a tail portion of the device 100 of FIG. 1.

As shown in FIGS. 21D and 21E, the concave portion 2140 is defined by sidewalls 2145, a back wall 2150, and a top wall 2155. The sidewalls 2145 of the concave portion 2140 terminate at the front of the frame 2010 to define a front opening 2170 and at the bottom of the frame 2010 to define a bottom opening 2165. Using these openings, the device 100 can be inserted into the attachment 2005 from the front opening 2170 or the bottom opening 2165 (or a combination). The sidewalls 2145 and top wall 2155 are illustrated as having a shape that generally conforms to the shape of the corresponding portion of the device 100. The back wall 2150 is illustrated as have a shape that does not conform to the tail portion of the device 100, although the back wall 2150 may be designed to contact the device at contact surfaces 2025 (see FIG. 20D). Thus, although the internal dimensions of the concave portion 1340 may not conform precisely to the shape of a corresponding portion of the device 100, the internal dimensions may include surfaces that contact the corresponding portion of the device 100 sufficiently to secure the attachment 2005 in place.

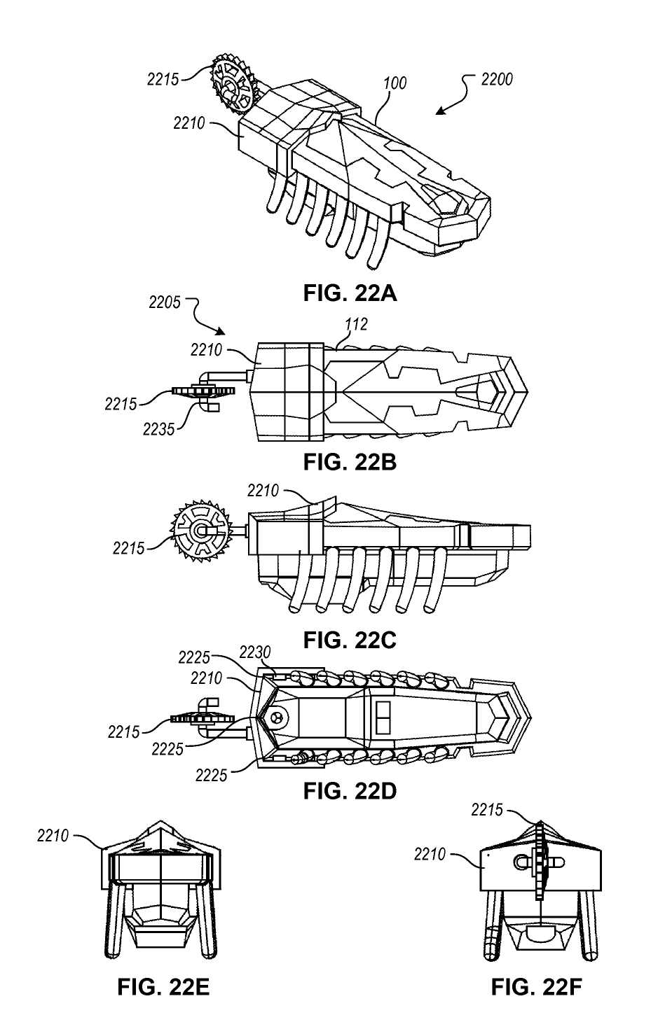

FIGS. 22A through 22F illustrate a vehicle 2200 that includes a device 100 of FIG. 1 fitted with a rear sideways spinning blade attachment 2205. FIG. 22A is a perspective view of the vehicle 2200, FIG. 22B is a top view of the vehicle 2200, FIG. 22C is a side view of the vehicle 2200, FIG. 22D is a bottom view of the vehicle 2200, FIG. 22E is a front view of the vehicle 2200, and FIG. 22F is a back view of the vehicle 2200. The rear sideways spinning blade attachment 2205 includes a frame 2210 and a spinning blade appendage 2215.

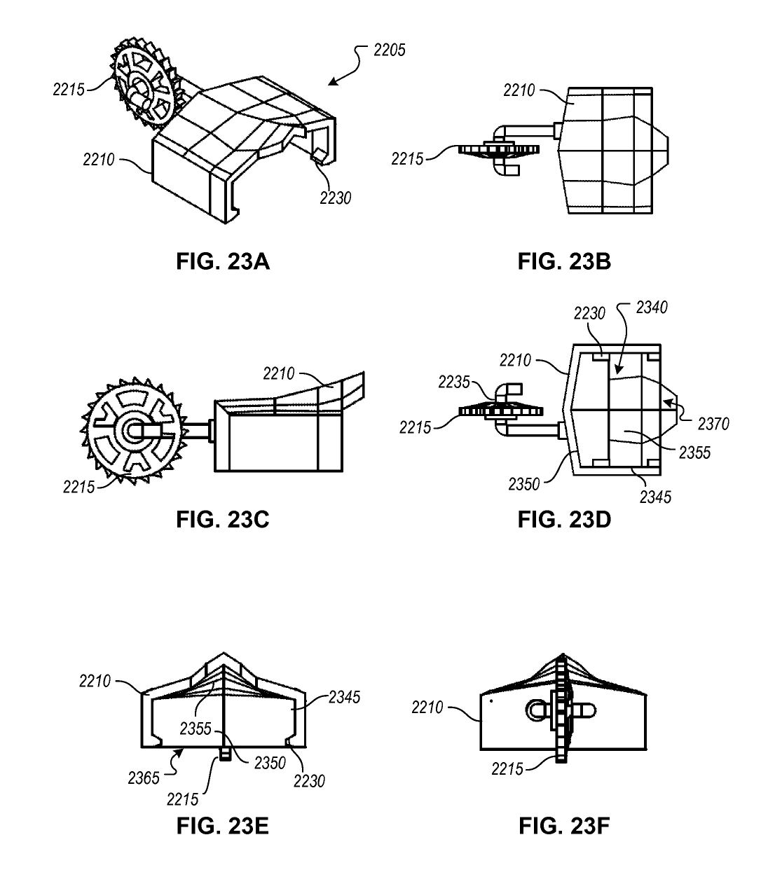

The frame 2210 can include features adapted to secure the attachment 2205 to the device 100. For example, the frame 2210 can include engage the tail end of the device 100 at contact points 2225. The frame 2210 can also include horizontal tabs 2230 adapted to engage the device 100 just under the body shoulders 112 to prevent unwanted movement of the attachment 2205 in an upward direction (i.e., in a direction away from a support surface 110 when the device 100 is upright). Essentially, the contact points 2225 and horizontal tabs 2230 (along with the shape of the internal top wall 2355 shown in FIG. 23E) can allow the attachment 2205 to snap into place on the device 100 and to be removed from the device 100 (e.g., using an amount of force greater than the device 100 experiences as a result of vibration during operation). The tabs 2230, the frame 2210, and/or the body 102 of the device 100 can be sufficiently flexible to deflect and/or deform, thereby allowing the attachment 2205 to be fitted onto the device 100 and removed from the device 100 by a user. The frame 2210 may be configured to have at least a somewhat different internal shape than the shape of the device body 102 (e.g., the back portion of the frame 2210 need not conform to the shape of tail end of the device 100, although, in some embodiments, frame 2210 can be configured to conform to the shape of the device tail). As noted above, in some embodiments the frame can be connected (integrally or otherwise) to the device body 102 instead of being a separate and/or removable component.

The spinning blade appendage 2215 is rotatably coupled to the frame 2210 of the rear sideways spinning blade attachment 2205 by an axle 2235 that defines an axis of rotation for the spinning blade appendage 2215. Other types of axles can also be used. Moreover, the axle can be fixedly attached to either the frame 2210 or the appendage 2215, or neither.

FIGS. 23A through 23F illustrate the rear sideways spinning blade attachment 2205 of FIG. 22 separate from the device 100. FIG. 23A is a perspective view of the rear sideways spinning blade attachment 2205, FIG. 23B is a top view of the rear sideways spinning blade attachment 2205, FIG. 23C is a side view of the rear sideways spinning blade attachment 2205, FIG. 23D is a bottom view of the rear sideways spinning blade attachment 2205, FIG. 23E is a front view of the rear sideways spinning blade attachment 2205, and FIG. 23F is a back view of the rear sideways spinning blade attachment 2205. FIGS. 23A-23F illustrate many of the same features as shown in FIGS. 22A-22F. In addition, FIGS. 23D and 23E illustrate additional details of a concave portion 2340 of the rear sideways spinning blade attachment 2205 that fits onto the device 100. In this case, for example, the concave portion 2340 is designed to substantially mate with a tail portion of the device 100 of FIG. 1.

As shown in FIGS. 23D and 23E, the concave portion 2340 is defined by sidewalls 2345, a back wall 2350, and a top wall 2355. The sidewalls 2345 of the concave portion 2340 terminate at the front of the frame 2210 to define a front opening 2370 and at the bottom of the frame 2210 to define a bottom opening 2365. Using these openings, the device 100 can be inserted into the attachment 2205 from the front opening 2370 or the bottom opening 2365 (or a combination). The sidewalls 2345 and top wall 2355 are illustrated as having a shape that generally conforms to the shape of the corresponding portion of the device 100. The back wall 2350 is illustrated as have a shape that does not conform to the tail portion of the device 100, although the back wall 2350 may be designed to contact the device at contact surfaces 2225 (see FIG. 22D). Thus, although the internal dimensions of the concave portion 2340 may not conform precisely to the shape of a corresponding portion of the device 100, the internal dimensions may include surfaces that contact the corresponding portion of the device 100 sufficiently to secure the attachment 2205 in place.

Attachments, such as those described above, can also be used in combination on a single device 100. For example, head, body, and/or rear attachments can be attached to a device 100 concurrently. The attachments can include both moving and non-moving appendages. In some cases, the attachments can overlap one another. For example, the frame of one attachment may overlap the frame of another attachment. In some embodiments, as discussed above, the attachments can be more permanently connected to the body 102 of the device 100 (e.g., integrally molded as one piece, co-molded as one piece, or otherwise connected together).

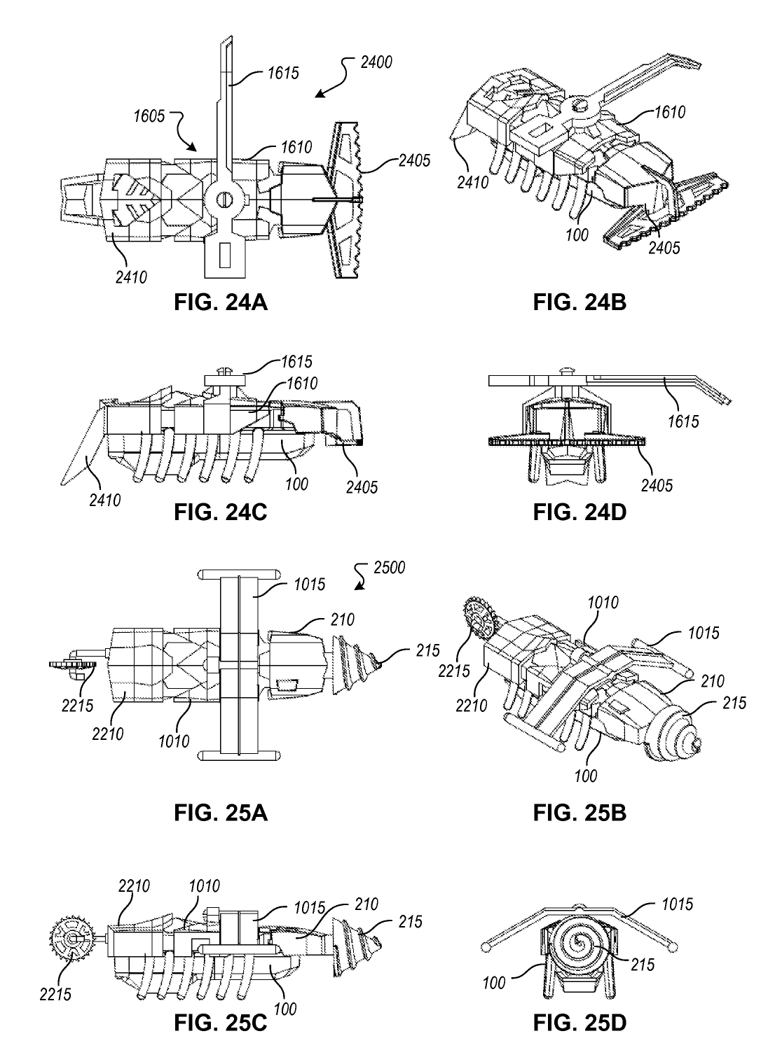

FIGS. 24A through 24D illustrate a vehicle 2400 that includes a device 100 of FIG. 1 fitted with both moving and non-moving parts, including a front sweeper attachment 2405, a rear dragging attachment 2410, and a spinning top blade body attachment 1605 (see FIGS. 16A-16F) that includes a frame 1610 and a spinning blade appendage 1615. FIG. 24A is a top view of the vehicle 2400, FIG. 24B is a perspective view of the vehicle 2400, FIG. 24C is a side view of the vehicle 2400, and FIG. 24D is a front view of the vehicle 2400. In this case, the front sweeper attachment 2405 and the rear dragging attachment 2410 attach in a manner similar to some of the attachments described above but do not include moving parts.

FIGS. 25A through 25D illustrate a vehicle 2500 that includes a device 100 of FIG. 1 fitted with multiple moving parts, including a spinning drill head attachment 205 that includes a frame 210 and a drill bit appendage 215 (see FIGS. 2A-2F), rocking wing body attachment 1005 includes a frame 1010 and a rocking wing appendage 1015 (see FIGS. 10A-10F), and a rear sideways spinning blade attachment 2205 includes a frame 2210 and a spinning blade appendage 2215 (see FIGS. 22A-22F). FIG. 25A is a top view of the vehicle 2500, FIG. 25B is a perspective view of the vehicle 2500, FIG. 25C is a side view of the vehicle 2500, and FIG. 25D is a front view of the vehicle 2500.

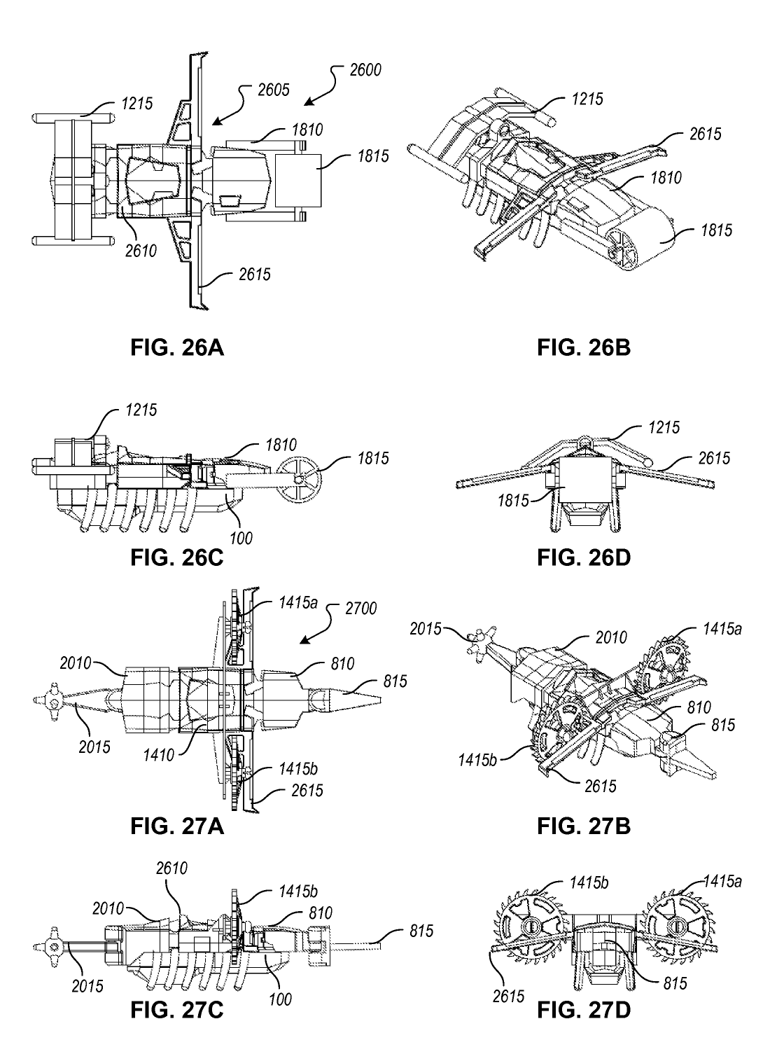

FIGS. 26A through 26D illustrate a vehicle 2600 that includes a device 100 of FIG. 1 fitted with both moving and non-moving parts, including a rocking wing tail attachment 1205 includes a frame 1210 and a rocking wing appendage 1215 (see FIGS. 12A-12F), a front rotating drum attachment 1805 includes a frame 1810 and a rotating drum appendage 1815 (see FIGS. 18A-18F), and a body sweeper attachment 2605 that includes a frame 2610 and a lateral sweeper appendage 2615. FIG. 26A is a top view of the vehicle 2600, FIG. 26B is a perspective view of the vehicle 2600, FIG. 26C is a side view of the vehicle 2600, and FIG. 26D is a front view of the vehicle 2600.

FIGS. 27A through 27D illustrate a vehicle 2700 that includes a device 100 of FIG. 1 fitted with both moving and non-moving parts, including a front waving side-to-side blade attachment 805 includes a frame 810 and a waving blade appendage 815 (see FIGS. 8A-8F), dual side saw blades attachment 1405 includes a frame 1410 and saw blade appendages 1415 (see FIGS. 14A-14F), a side-to-side waving tail attachment 2005 includes a frame 2010 and a waving tail appendage 2015 (see FIGS. 20A-20F), and a body sweeper attachment 2605 that includes a frame 2610 and a lateral sweeper appendage 2615. FIG. 27A is a top view of the vehicle 2700, FIG. 27B is a perspective view of the vehicle 2700, FIG. 27C is a side view of the vehicle 2700, and FIG. 27D is a front view of the vehicle 2700. In the illustrated embodiment, the frame 1410 of the dual side saw blades attachment 1405 is fitted on the device 100 over the frame 2610 of the lateral sweeper appendage 2615.

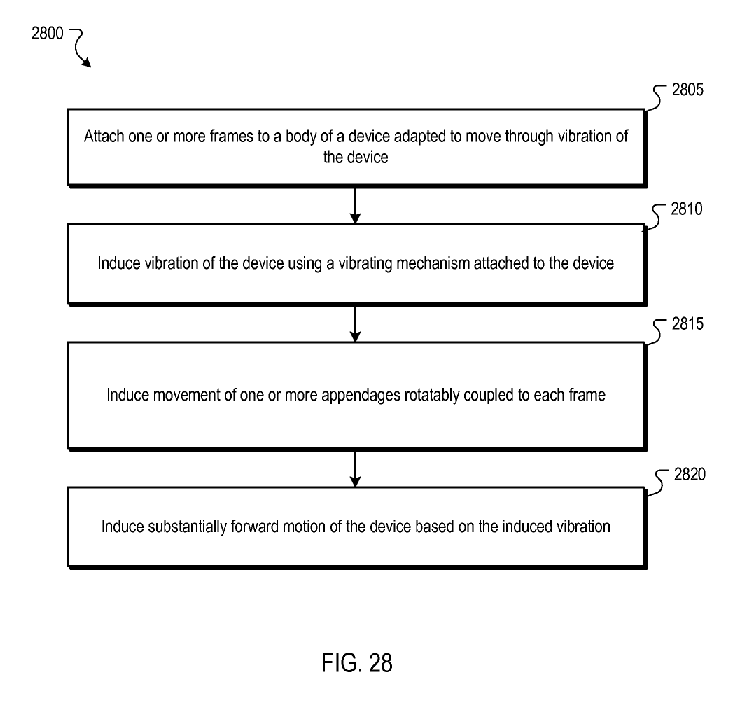

FIG. 28 is a flow diagram of a process 2800 for using a device and one or more attachments, such as the device 100 and any of the attachments described above. The process 2800 includes attaching a frame to a body of a device that is designed and configured to move based on vibration of the device at 2805. The frame can be attached to the body of the device through an engagement between an interior concave portion shaped to substantially conform to an exterior portion of the body of the device. The attachment can be accomplished by engaging the body of the device with a plurality of tabs attached to the frame and one or more surfaces of the frame opposing the plurality of tabs (e.g., front wall 350 opposing vertical tabs 225 and top wall 355 opposing horizontal tabs 230 of FIGS. 3D and 3F). The tabs, body of the device, and/or the frame can be configured or constructed to allow disengaging the frame from the device (e.g., by disengaging the tabs from the body of the device). In some embodiments, however, the frame can be integrally formed with the body of the device or the appendage can be rotatably connected directly to the body of the device. In some cases, more than one frame can be attached to the device. Vibration of the device is induced using a vibrating mechanism attached to the device at 2810. For example, the vibrating mechanism can include a rotational motor coupled to the body of the device and adapted to rotate an eccentric load.

Movement of an appendage rotatably coupled to the frame is induced at 2815. For example, the movement of the appendage can include rotation about an axis of rotation. The axis of rotation can be defined by an axle that rotatably couples the appendage to the frame. The movement can result from vibration of the device and/or other forces that are induced by the vibrating mechanism when the frame is attached to the body of the device. Each frame can include one or more appendages, and each appendage can be rotatably or fixedly coupled to the corresponding frame. In some cases, a coupling between an appendage and the corresponding frame can allow other types of movement in addition to or other than rotation. Substantially forward motion of the device (e.g., across a support surface) can be induced at 2820 based on the induced vibration. The axis of rotation for a particular rotating appendage can be situated at least substantially parallel to a direction of forward motion of the device or situated at least substantially perpendicular to a direction of forward motion of the device. The appendage (e.g., drill bit appendage 215 of FIGS. 2A-2F and 3A-3F) can repeatedly and substantially continuously rotate in a particular direction based on forces induced from the vibration of the device when the frame is attached to the body of the device. Alternatively, the appendage (e.g., waving blade appendage 815 of FIGS. 8A-8F and 9A-9F) can rotate back and forth as the device vibrates when the frame is attached to the body of the device.

Thus, particular embodiments of the subject matter have been described. Other embodiments are within the scope of the following claims.

What is claimed is:

1. An apparatus comprising:
a frame adapted to releasably attach to a body of a device adapted to move based on internally induced vibration of the device; and
an appendage rotatably coupled to the frame, wherein the appendage is adapted to rotate about an axis of rotation when the frame is attached to the body of the device as vibration induces motion of the device.

2. The apparatus of claim 1 wherein the frame includes a plurality of tabs adapted for releasably attaching the frame to the body of the device.

3. The apparatus of claim 2 wherein the frame further includes a surface opposing the plurality of tabs, the surface and the plurality of tabs adapted to engage a portion of the body of the device.

4. The apparatus of claim 3 wherein the frame includes an interior concave portion shaped to substantially conform to an exterior portion of the body of the device.

5. The apparatus of claim 4 wherein the axis of rotation is defined by an axle that rotatably couples the appendage to the frame.

6. The apparatus of claim 1 wherein the axis of rotation is situated at least substantially parallel to a direction of movement of the device as vibration induces motion of the device when the frame is attached to the body of the device.

7. The apparatus of claim 1 wherein the axis of rotation is situated at least substantially perpendicular to a direction of movement of the device as vibration induces motion of the device when the frame is attached to the body of the device.

8. The apparatus of claim 1 wherein the appendage is adapted to rotate in a particular direction based on the vibration of the device when the frame is attached to the body of the device.

9. The apparatus of claim 1 wherein the appendage is adapted to rotate back and forth as the device vibrates when the frame is attached to the body of the device.

10. The apparatus of claim 1 further comprising a plurality of appendages rotatably coupled to the frame, wherein each appendage is adapted to rotate about a respective axis of rotation when the frame is attached to the body of the device as vibration induces motion of the device.

11. The apparatus of claim 1 wherein the frame is substantially rigid.

12. The apparatus of claim 1 wherein internally induced vibration of the device is induced using:
a rotational motor coupled to the body of the device; and
an eccentric load, wherein the rotational motor is adapted to rotate the eccentric load.

13. The apparatus of claim 12 wherein the axis of rotation is situated at least substantially parallel to a rotational axis of the rotational motor as the rotational motor rotates the eccentric load when the frame is attached to the body of the device.

14. The apparatus of claim 12 wherein the axis of rotation is situated at least substantially perpendicular to a rotational axis of the rotational motor as the rotational motor rotates the eccentric load when the frame is attached to the body of the device.

15. The apparatus of claim 1 wherein the appendage is configured to resemble one of a saw blade, a swinging blade, a rocking wing, a steammoller drum, or a drill bit.

16. The apparatus of claim 1 wherein the motion of the device includes vibration-induced motion across a support surface for the device.

17. A method comprising:
attaching a frame to a body of a device adapted to move based on vibration of the device;
inducing vibration of the device using a vibrating mechanism attached to the device; and
inducing movement of an appendage rotatably coupled to the frame, wherein the movement of the appendage includes rotation about an axis of rotation and is based on vibration of the device induced by the vibrating mechanism when the frame is attached to the body of the device.

18. The method of claim 17 further comprising attaching at least a first frame and a second frame to different sections of the body of the device, wherein each frame is rotatably coupled to at least one appendage adapted to rotate about a respective axis of rotation.

19. The method of claim 17 wherein attaching the frame to the body of the device includes engaging the body of the device with a plurality of tabs attached to the frame and a surface of the frame opposing the plurality of tabs.

20. The method of claim 19 further comprising disengaging the plurality of tabs to remove the frame from the body of the device.

21. The method of claim 19 wherein attaching the frame to the body of the device includes engaging an interior concave portion shaped to substantially conform to an exterior portion of the body of the device.

22. The method of claim 17 wherein the axis of rotation is defined by an axle that rotatably couples the appendage to the frame.

23. The method of claim 17 further comprising inducing substantially forward motion of the device based on the induced vibration, wherein the axis of rotation is situated at least substantially parallel to a direction of forward motion of the device.

24. The method of claim 17 further comprising inducing substantially forward motion of the device based on the induced vibration, wherein the axis of rotation is situated at least substantially perpendicular to a direction of forward motion of the device.

25. The method of claim 17 wherein the appendage repeatedly and substantially continuously rotates in a particular direction based on the vibration of the device when the frame is attached to the body of the device.

26. The method of claim 17 wherein the appendage rotates back and forth as the device vibrates when the frame is attached to the body of the device.

27. The method of claim 17 wherein vibration of the device is induced using:
a rotational motor coupled to the body of the device; and
an eccentric load, wherein the rotational motor is adapted to rotate the eccentric load.

28. The method of claim 17 wherein the vibration of the device induces motion across a support surface for the device.

29. An apparatus comprising:
a body;
an appendage rotatably coupled to the body;
a rotational motor coupled to the body;
an eccentric load, wherein the rotational motor is adapted to rotate the eccentric load, wherein the appendage is adapted to rotate about an axis of rotation due to forces induced when the rotational motor rotates the eccentric load; and
a plurality of legs each having a leg base and a leg tip at a distal end relative to the leg base, wherein the plurality of legs include at least one driving leg configured to cause the apparatus to move in a direction generally defined by an offset between the leg base and the leg tip as the rotational motor rotates the eccentric load.

30. The apparatus of claim 29 wherein at least a portion of the plurality of legs:
are constructed from a flexible material;
are injection molded; and
are integrally coupled to the body at the leg base.

31. The apparatus of claim 29 wherein the legs are arranged in two rows, with the leg base of the legs in each row coupled to the body substantially along a lateral edge of the body.

32. The apparatus of claim 31 wherein the body includes a housing, the rotational motor is situated within the housing, and at least a portion of the housing is situated between the two rows of legs.

33. The apparatus of claim 29 wherein the rotational motor has an axis of rotation that passes within about 20% of the center of gravity of the apparatus as a percentage of the height of the apparatus.

34. The apparatus of claim 29 wherein the plurality of legs are arranged in two rows and the rows are substantially parallel to the axis of rotation of the rotational motor, and wherein at least some of the leg tips tend to substantially prevent rolling of the apparatus based on a spacing of the two rows of legs when the legs are oriented such that a leg tip of at least one leg on each lateral side of the body contacts a substantially flat surface.

35. The apparatus of claim 29 wherein forces from rotation of the eccentric load interact with a resilient characteristic of the at least one driving leg to cause the at least one driving leg to leave a support surface as the apparatus translates in the forward direction.

36. The apparatus of claim 29 wherein a coefficient of friction of a portion of at least a subset of the legs that contact a support surface is sufficient to substantially eliminate drifting in a lateral direction.

37. The apparatus of claim 29 wherein the legs are sufficiently stiff that four or fewer legs are capable of supporting the apparatus without substantial deformation when the apparatus is in an upright position.

38. The apparatus of claim 29 wherein the eccentric load is configured to be located toward a front end of the apparatus relative to the driving legs, wherein the front end of the apparatus is defined by an end in a direction that the apparatus primarily tends to move as the rotational motor rotates the eccentric load.

39. The apparatus of claim 29 wherein the plurality of legs are integrally molded with at least a portion of the body.

40. The apparatus of claim 29 wherein the plurality of legs are co-molded with at least a portion of the body constructed from a different material.

41. The apparatus of claim 29 wherein at least a subset of the plurality of legs, including the at least one driving leg, are curved, and a ratio of a radius of curvature of the curved legs to leg length of the curved legs is in a range of 2.5 to 20.

42. The apparatus of claim 29 wherein the flexible material includes an elastomer.

43. The apparatus of claim 29 wherein each of the plurality of legs has a diameter of at least five percent of a length of the leg between the leg base and the leg tip.
